(19) United States
(12) Patent Application Publication
(10) Pub. No.: US 2018/0022884 A1
(43) Pub. Date: Jan. 25, 2018

(54) POLYESTER POLYOL COMPOSITIONS CONTAINING HFO-1336MZZM (Z)

(71) Applicant: HONEYWELL INTERNATIONAL INC., MORRIS PLAINS, NJ (US)

(72) Inventors: MARY C. BOGDAN, BUFFALO, NY (US); DAVID J. WILLIAMS, EAST AMHERST, NY (US); YIU K. LING, AMHERST, NY (US); RONALD S. GROSSMAN, BUFFALO, NY (US); BIN YU, TONAWANDA, NY (US)

(21) Appl. No.: 15/631,709

(22) Filed: Jun. 23, 2017

Related U.S. Application Data
(60) Provisional application No. 62/366,437, filed on Jul. 25, 2016.

(51) Int. Cl. C08J 9/06; C08G 63/06; C08G 63/12; C08J 9/35

(52) U.S. Cl. CPC C08J 9/06; C08J 9/35; C08G 63/06; C08G 63/12; C08J 2201/022; C08J 2205/06; C08J 2205/08; C08J 2205/10

(57) ABSTRACT

Blends, polyol premix compositions, methods of forming such compositions, foamable compositions using the premix compositions, methods of preparing foams containing the premix compositions, and foams made using the premix compositions are described. The polyol premix composition includes a polyester polyol; halogenated olefin blowing agent; and a distribution-enhancing component. In the polyol premix composition, the blowing agent, the polyester polyol, and the distribution-enhancing component form a substantially uniform composition.

### CROSS-REFERENCE TO RELATED APPLICATIONS

This application claims the priority benefit of U.S. provisional application No. 62/366,437, filed Jul. 25, 2016, the contents of which is incorporated herein by reference.

The present invention pertains to polyurethane and polyisocyanurate foams and methods for the preparation thereof. More particularly, the invention relates to rigid, semi-rigid, and flexible polyurethane and polyisocyanurate foams and methods for their preparation using halogenated olefins as a blowing agent, including cis-1,1,1,4,4,4-hexafluorobut-2-ene (HFO-1336mzzm(Z)), and polyester polyols

### BACKGROUND OF THE INVENTION

The class of foams known as low density, rigid, semi-rigid, and flexible polyurethane or polyisocyanurate foams has utility in a wide variety of insulation applications including roofing systems, building panels, building envelope insulation, refrigerators and freezers, seat cushions, mattresses, shoe soles, packaging materials, and the like. A critical factor in the large-scale commercial acceptance of rigid polyurethane foams has been their ability to provide a good balance of properties. Rigid, closed cell polyurethane and polyisocyanurate foams are known to provide outstanding thermal insulation, excellent fire resistance properties, and superior structural properties at reasonably low densities. Semi-flexible and flexible polyurethane foams are known to provide superior cushioning and energy absorption properties. The foam industry has historically used certain liquid fluorocarbon materials as blowing agents because of their ease of use under typical processing conditions. Certain fluorocarbons can not only act as blowing agents by virtue of their volatility, but in the case of closed cell foams, are also encapsulated or entrained in the closed cell structure of the rigid foam and are the major contributor to the low thermal conductivity properties of the rigid urethane foams. The use of certain fluorocarbon materials as preferred commercial expansion or blowing agent in insulating foam applications is based in part on the resulting k-factor associated with the foam produced. The k-factor is defined as the rate of transfer of heat energy by conduction through one square foot of one-inch thick homogenous material in one hour where there is a difference of one degree Fahrenheit perpendicularly across the two surfaces of the material. Since the utility of many closed-cell polyurethane-type foams is based, in part, on the thermal insulation properties of the foam, it would be advantageous to identify materials that produce lower k-factor foams. In the case of flexible polyurethane foam, physical blowing agents, including certain fluorocarbons, are used to reduce the density of these foams to levels difficult to achieve using water alone.

It is known in the art to produce polyurethane and polyisocyanurate foams by reacting a polyisocyanate with a polyol in the presence of a blowing agent, a catalyst, a surfactant and optionally other ingredients. For many applications, the blowing agent should be substantially homogeneously distributed in the polyol component. Heat generated when the polyisocyanate reacts with the polyol volatilizes the blowing agent contained in the liquid mixture, forming bubbles therein. As the polymerization reaction proceeds, the liquid mixture becomes a polymeric, cellular solid, entrapping the blowing agent in the foam's cells in closed cell foams. In many applications, if a surfactant is not used in the foaming composition, the bubbles simply pass through the liquid mixture without forming a foam or forming a foam with large, irregular cells rendering it not useful for rigid foam. Also, if the blowing agent is in not substantially uniformly distributed in the foamable composition during foaming, irregular and inconsistent foams will be formed.

Suitable blowing agents include certain fluorocarbons, chlorocarbons, chlorofluorocarbons, hydrohaloolefins, hydrocarbons, ethers, esters, aldehydes, ketones, acetals, organic acids, atmospheric gases, materials that generate gas, for example CO2, through decomposition or chemical reaction, such as, but not limited to, water, formic acid, and azodicarbonamide, and mixtures of two or more of these. Preferred blowing agents have low global warming potential. Among these blowing agents are certain hydrohaloolefins including hydrofluoroolefins (HFOs) (which include hydrochlorofluoroolefins (also known as HFCOs). Of particular interest are trans-1,3,3,3-tetrafluoropropene (HFO-1234ze(E)), cis-1,1,1,4,4,4-hexafluorobut-2-ene (HFO-1336mzz(Z)), and trans-1-chloro-3,3,3-trifluoropropene (HFO-1233zd(E)). Processes for the manufacture of 1,3,3,3-tetrafluoropropene are disclosed in U.S. Pat. Nos. 7,230,146 and 7,189,884. Processes for the manufacture of 1-chloro-3,3,3-trifluoropropene are disclosed in U.S. Pat. Nos. 6,844,475 and 6,403,847. As used herein, the designation “(E)” represents the trans isomer of the molecule and “(Z)” represents the cis isomer.

It is convenient in many applications to provide the components for polyurethane or polyisocyanurate foams in pre-blended formulations. Most typically, the foam formulation is pre-blended into two components. The polyisocyanate and optional isocyanate compatible raw materials comprise the first component, commonly referred to as the “A” component. A polyol or mixture of polyols, surfactant, catalyst, blowing agent, and other isocyanate reactive and non-reactive components comprise the second component, commonly referred to as the “B” component. Accordingly, polyurethane or polyisocyanurate foams are readily prepared by bringing together the A and B side components either by hand mix for small preparations and, preferably, machine mix techniques to form blocks, slabs, laminates, pour-in-place panels, flexible foam, shoe soles, and other items, spray applied foams, froths, molded articles, and the like. Optionally, all or part of the blowing agent, together with other ingredients such as flame retardants, colorants, auxiliary blowing agents, and other polyols, can be added to the mixing head or reaction site. Most conveniently, however, they are all incorporated into one B component.

In order for the physical blowing agent to yield a foam with uniform density and cell structure, the blowing agent must be substantially uniformly distributed, for example by being dissolved, dispersed and/or emulsified in the polyol, thereby forming a substantially homogeneous blend of polyol and blowing agent. The mixture needs to remain homogeneous and not froth when agitated during transportation. There are many types of polyols utilized in the manufacture of polyurethane or polyisocyanurate foam. Most polyurethane or polyisocyanurate foams are prepared from a blend of polyols with different structures and properties. The polyols used directly impact the physical properties of the polyurethane or polyisocyanurate foam. In each polyurethane or polyisocyanurate foam application, the selection of polyols varies, as does the concentration of blowing agent. The majority of polyols used fall into 2 classes, polyether and polyester. The structure of the polyols in each class varies. The use of polyester polyols is important to many applications. In some formulations, 100% of the polyols used are polyester polyols. Applicants have come to appreciate that an important consideration in formulation development is how much blowing agent can be uniformly distributed in the polyol blend over a range of temperatures, including the range of temperatures at which the blend will be formed, stored and transported (e.g., from −20° C. to 50° C.) and/or the range of temperatures over which the foam will be formed (e.g., 10° C. to 55° C.). In addition to being uniform, the blend should not froth.

### SUMMARY OF THE INVENTION

Applicants have come to appreciate that certain polyols do not readily form uniform distributions with certain blowing agents under the conditions and in the presence of other materials that have heretofore been used. The blends can froth creating issues for transportation and use. Applicants have found that the inclusion of certain materials in the blend can overcome these deficiencies and improve or enhance the degree of uniform distribution achieved in those cases in which the blowing agent would otherwise be poorly and not substantially uniformly distributed in the polyol.

One aspect of the present invention relates to polyol premix compositions in which the polyol premix composition comprises: (a) polyester polyol (b) blowing agent comprising a halogenated olefin blowing agent, preferably C3 or C4 halogenated olefin, and even more preferably where the blowing agent comprises cis-1,1,1,4,4,4-hexafluorobut-2-ene, also referred to as HFO-1336mzzm(Z), and (c) at least one distribution-enhancing component that enables uniform distribution and/or improves the uniformity of the distribution of the haloolefin blowing agent in the polyester polyol. As used herein, the distribution-enhancing component selected according to the present invention is also sometimes referred to herein by way of convenience as a “compatibilizer.” One indicia that a substantially uniform distribution of blowing agent has not been achieved is the visual observation, preferably under conditions as described in the examples hereof, of phase separation after attempting to blend/mix the components. Conversely, one indicia in preferred embodiments of the existence of substantially uniform distribution is the visual observation, preferably under conditions as described in the examples hereof, of a substantially consistent liquid phase with no indication of phase separation.

Other aspects of the present invention include blends, methods of preparing foamable compositions, foamable compositions, and foams.

One aspect of the invention is the selection of an organic compatibilizer, preferably an organic, hydroxyl-containing compound having from 1 to 40 carbon atoms, and even more preferably from 1 to 25 carbon atoms. In certain preferred embodiments, the compatibilizer is selected from the group consisting of non-cyclic alcohols having 1 to 10 carbon atoms, cyclic alcohols having 6 to 40 carbon atoms, alkylphenols and alkylphenol ethoxylates, dipropylene glycol, diisopropylene glycol, dipropylene glycol methyl ether, methylal (methylene dimethyl ether), ethylene glycol mono-butyl ether, 1,3-diisopropenyl benzene, isopropenyl benzene, acetone, methyl ethyl ketone, trans-1,2-dichloroethylene, 2-chloropropane, trans-1-chloro-3,3,3-trifluoropropene, methyl formate, propylene carbonate, dioctyl phthalate, toluene, tris(1-chloro-2-propyl) phosphate, and combinations of any two or more of these.

In certain aspects, the present invention comprises a blend comprising a distribution-enhancing component, and preferably a distribution-enhancing component as identified in the preceding paragraph or as described elsewhere herein; and either (a) a halogenated olefin blowing agent, or (b) a polyester polyol. In preferred embodiments, the halogenated blowing agent comprises, or may consist essentially of, or may consist of, cis-1,1,1,4,4,4-hexafluorobut-2-ene. Preferably, the blend is formed as a substantially uniform blend or mixture of components, and even more preferably the blowing agent or the polyester polyol, whichever is present, is solvated by and/or substantially uniformly dispersed in and/or substantially uniformly emulsified in the compatibilizer, or in the alternative the compatibilizer is solvated by and/or substantially uniformly dispersed in and/or substantially uniformly emulsified in the blowing agent or the polyester polyol, whichever is present. In such embodiments, it is also highly preferred that the solution/dispersion/emulsion is stable upon storage, preferably upon storage for a period of four months, more preferably for a period of six months, and even more preferably for a period of 1 year, with the storage temperature being under expected ambient temperature conditions, in a sealed container. In certain preferred embodiments, stable storage exists according to the present invention at temperatures of from about −20° C. to about 55° C.

Another aspect of the invention is a polyol premix composition. In one embodiment, the polyol premix composition includes at least one polyester polyol; cis-1,1,1,4,4,4-hexafluorobut-2-ene blowing agent; and a distribution-enhancing component of the present invention, preferably a compatibilizer selected from the group consisting of non-cyclic alcohols having 1 to 10 carbon atoms, cyclic alcohols having 6 to 40 carbon atoms, alkylphenols and alkylphenol ethoxylates, ethylene glycol, diisopropylene glycol, dipropylene glycol methyl ether, methylal, ethylene glycol mono-butyl ether, 1,3-diisopropyl benzene, isopropyl benzene, 1,3-diisopropenyl benzene, isopropenyl benzene, acetone, methyl ethyl ketone, trans-1,2-dichloroethylene, 2-chloropropane, trans-1-chloro-3,3,3-trifluoropropene, methyl formate, propylene carbonate, dioctyl phthalate, toluene, tris(1-chloro-2-propyl) phosphate, and combinations of any two or more of these, wherein the blowing agent and the distribution-enhancing component are substantially uniformly distributed as a blend or in the polyol premix, preferably by said blowing agent and distribution-enhancing component being substantially uniformly dispersed in and/or emulsified in and/or solvated by the polyol.

Another aspect of the invention is a method of forming a polyol premix composition. In one embodiment, the method includes combining (a) a polyester polyol; (b) blowing agent comprising, and even more preferably comprising at least about 50% by weight of, and even more preferably consisting essentially of, cis-1,1,1,4,4,4-hexafluorobut-2-ene; (c) a distribution-enhancing component selected from the group consisting of non-cyclic alcohols having 1 to 10 carbon atoms, cyclic alcohols having 6 to 40 carbon atoms, alkylphenols and alkylphenol ethoxylates, ethylene glycol, dipropylene glycol, diisopropylene glycol, dipropylene glycol methyl ether, methylal, ethylene glycol mono-butyl ether, 1,3-diisopropyl benzene, isopropyl benzene, 1,3-diisopropenyl benzene, isopropenyl benzene, acetone, methyl ethyl ketone, trans-1,2-dichloroethylene, 2-chloropropane, trans-1-chloro-3,3,3-trifluoropropene, methyl formate, propylene carbonate, dioctyl phthalate, toluene, tris(1-chloro-2-propyl) phosphate, and combinations of any two or more of these, wherein the blowing agent, and the distribution-enhancing component are substantially uniformly distributed in the polyol, preferably by said blowing agent and distribution-enhancing component being substantially uniformly dispersed in and/or emulsified in and/or solvated by the polyol; (d) an amine catalyst; and (e) a silicone surfactant.

Another aspect of the invention is a foamable composition. In one embodiment, the foamable composition comprises a mixture of an organic polyisocyanate and a polyol premix composition according to the present invention.

Another aspect of the invention is a method of preparing a polyurethane or polyisocyanurate foam. In one embodiment, the method includes reacting an organic polyisocyanate with a polyol premix composition according to the present invention.

Another aspect of the invention is a foam produced according to a method which utilizes a compatibilizer blend, and/or a polyol premix, and/or a foamable composition of the present invention.

### DESCRIPTION OF THE INVENTION

HFO-1336mzzm(Z) is a recently developed hydrohaloolefin. As discussed below, the ability of HFO-1336mzzm(Z) to be uniformly distributed in various polyester polyols was compared with that of two other commonly used blowing agents, 1,1,1,3,3-pentafluoropropane (HFC-245fa), and trans-1-chloro-3,3,3-trifluoropropene (HFO-1233zd(E)), at different concentrations and temperatures. It was discovered that the ability of HFO-1336mzzm(Z) to achieve uniform distribution varied significantly with respect to the polyester polyol used, concentration, and temperature, and that in the absence of the invention described herein, HFO-1336mzzm(Z) was surprisingly found to be, at best, only poorly distributed in a number of commonly used polyester polyols. This would severely restrict its use as a substantial component of the blowing agent in polyurethane or polyisocyanurate foams. Although applicants have found that HFO-1233zd(E) appears to have a superior capability to produce a uniform distribution with several polyol esters compared to HFO-1336mzzm(Z), applicants have also found that it is possible to achieve improved or enhanced distribution of blowing agents comprising HFO-1233zd(E) and less solution froth such blowing agents are used in accordance with the teachings contained herein. Applicants have also surprisingly found that certain compounds are able to enhance the extent to which halogenated olefins, more preferably C3 and C4 halogenated olefins, such as HFO-1336mzzm(Z), can be uniformly distributed in certain polyester polyols used in polyol premix compositions. As mentioned above, these compounds and blends of compounds are referred to herein as compatibilizers. The compatibilizer preferably is solvated by, dispersible in, and/or emulsified in, the halogenated olefin, such as HFO-1336mzzm(Z), and/or the polyester polyol, and preferably both. Furthermore, the uniform distribution thus formed is preferably a stable, substantially uniform distribution of blowing agent in the polyol. As used herein, a stable substantially uniform distribution means that substantially uniform distribution is maintained at at least one temperature, and preferably over the entire range of temperatures, from about −20° C. to about 55° C. when stored for a period of four months, preferably for a period of six months, and even more preferably a period of a year. In preferred embodiments, the stable, substantially uniform distribution comprises a stable solution and/or dispersion and/or emulsion of the blowing agent in the polyol. Desirably, the compatibilizer could be used with a wide variety of polyester polyols, over a wide range of concentrations, and storage stability is exhibited at least over the preferred range of temperatures described herein.

Desirably, the compatibilizer can be combined with the HFO-1336mzzm(Z), or the polyester polyol, or a mixture of the HFO-1336mzzm(Z), the polyester polyol, and any other components in the polyol premix composition.

A variety of materials were studied to determine their effectiveness as compatibilizers in a variety of polyols. The distribution-enhancing component typically has 1 to 40 carbon atoms. In some embodiments, the distribution-enhancing component has one or more hydroxyl groups. The distribution-enhancing component may comprise one of more of alcohols, glycols, ethers, acetals, benzenes, ketones, chlorinated solvents, carbonates, solvents, and surfactants.

Applicants have found that preferred compatibilizers include, but are not limited to, non-cyclic alcohols having 1 to 10 carbon atoms, cyclic alcohols having 6 to 40 carbon atoms (preferably from about 6 to about 15 carbon atoms), alkylphenols and alkylphenol ethoxylates, ethylene glycol, dipropylene glycol, diisopropylene glycol, dipropylene glycol methyl ether, methylal, ethylene glycol mono-butyl ether, 1,3-diisopropyl benzene, isopropyl benzene, 1,3-diisopropenyl benzene, isopropenyl benzene, acetone, methyl ethyl ketone, trans-1,2-dichloroethylene, 2-chloropropane, trans-1-chloro-3,3,3-trifluoropropene, methyl formate, propylene carbonate, dioctyl phthalate, toluene, tris(1-chloro-2-propyl) phosphate (TCPP) and combinations of any two or more of these.

The preferred non-cyclic alcohols can be linear or branched and preferably have 1 to 10 carbon atoms, or 1 to 9 carbon atoms, or 1 to 8 carbon atoms, or 1 to 7 carbon atoms, or 1 to 6 carbon atoms, or 1 to 5 carbon atoms, or 2 to 5 carbon atoms, or 2 to 4 carbon atoms. The preferred non-cyclic alcohols are mono-functional alcohols. Preferred mono-functional alcohols are ethanol, methanol, isopropanol, n-butanol, 2-propanol, 1 pentanol, 3-methyl-2-butanol, and 2-methyl-1-propanol.

The preferred cyclic alcohols preferably have 6 to 40 carbon atoms, or 6 to 35 carbon atoms, or 6 to 30 carbon atoms, or 6 to 25 carbon atoms, or 6 to 20 carbon atoms, or 6 to 15 carbon atoms, or 6 to 14 carbon atoms, or 6 to 12 carbon atoms, or 6 to 10 carbon atoms, or 6 to 9 carbon atoms, or 6 to 8 carbon atoms.

In some embodiments, the compatibilizer comprises alkylphenols, and in preferred embodiments alkylphenol alkoxylates, including, for example, alkylphenol ethoxylates. Specific preferred embodiments include, but are not limited to, nonylphenol, and nonylphenol ethoxylates.

One aspect of the invention provides a blend of a compatibilizer and either HFO-1336mzzm(Z) or a polyester polyol. Another aspect provides a polyol premix composition comprising compatibilizer, HFO-1336mzzm(Z), and a polyester polyol. Other aspects provide methods of preparing the polyol premix composition, and methods preparing a polyurethane or polyisocyanurate foam using the polyol premix composition, as well as foamable compositions using the polyol premix composition.

One aspect of the invention is a compatibilizer blend. In some embodiments, the compatibilizer blend comprises compatibilizer according to the present invention and HFO-1336mzzm(Z). The compatibilizer blend can comprises compatibilizer and a polyester polyol. The compatibilizer blend can include one or more compatibilizers, as desired.

The compatibilizer can be present based on the amount of the compatibilizer and blowing agent, or on the amount of the compatibilizer and the polyester polyol, as appropriate, in an amount of from about 0.5 wt % to about 10 wt % or about 0.5 wt % to about 9 wt %, or about 0.5 wt % to about 8 wt %, or about 0.5 wt % to about 7 wt %, or about 0.5 wt % to about 6 wt %, or about 0.5 wt % to about 5 wt %, or about 1 wt % to about 10 wt %, or about 2 wt % to about 10 wt %, or about 3 wt % to about 10 wt %, or about 4 wt % to about 10 wt %.

Another aspect of the invention is a polyol premix composition. The polyol premix composition includes polyester polyol, halogenated olefin blowing agent, preferably C3 or C4 halogenated olefin, and even more preferably cis-1,1,1,4,4,4-hexafluorobut-2-ene blowing agent, and compatibilizer. The blowing agent or the polyester polyol or both together form a stable, substantially homogeneous combination of components, and in preferred embodiments this is achieved by the combination of components forming a stable solution, dispersion and/or emulsion.

The compatibilizer can be present in an amount of at least about 1.7 wt % of the polyol premix composition.

In connection with polyol premix compositions, the compatibilizer can be present in the polyol premix, based on the total weight of the components in the premix composition, in an amount of about 0.01 wt % to about 10 wt %, or about 0.01 wt % to about 9 wt %, or about 0.01 wt % to about 8 wt %, or about 0.01 wt % to about 7 wt %, or about 0.01 wt % to about 6 wt %, or about 0.01 wt % to about 5 wt %, or about 0.05 wt % to about 10 wt %, or about 0.05 wt % to about 9 wt %, or about 0.05 wt % to about 8 wt %, or about 0.05 wt % to about 7 wt %, or about 0.05 wt % to about 6 wt %, or about 0.05 wt % to about 5 wt %, or about 0.1 wt % to about 10 wt %, or about 0.1 wt % to about 9 wt %, or about 0.1 wt % to about 8 wt %, or about 0.1 wt % to about 7 wt %, or about 0.1 wt % to about 6 wt %, or about 0.1 wt % to about 5 wt %, or about 0.3 wt % to about 10 wt %, or about 0.3 wt % to about 9 wt %, or about 0.3 wt % to about 8 wt %, or about 0.3 wt % to about 7 wt %, or about 0.3 wt % to about 6 wt %, or about 0.3 wt % to about 5 wt %, or about 0.5 wt % to about 9 wt %, or about 0.5 wt % to about 8 wt %, or about 0.5 wt % to about 7 wt %, or about 0.5 wt % to about 6 wt %, or about 0.5 wt % to about 5 wt %, or about 1 wt % to about 10 wt %, or about 2 wt % to about 10 wt %, or about 3 wt % to about 10 wt %, or about 4 wt % to about 10 wt %.

In connection with polyol premix compositions, the polyester polyol can be present in the polyol premix in an amount of about 50 wt % to about 98 wt %, and the blowing agent can be present in an amount of about 0.25 wt % to about 50 wt %, based on the total weight of the components in the polyol premix composition.

In connection with polyol premix compositions, the polyester polyol can bepresent in the polyol premix composition in an amount, based on the total weight of the components in the premix composition, of about 55 wt % to about 98 wt % of the polyol premix composition, or about 60 wt % to about 98 wt %, or about 65 wt % to about 98 wt %, or about 70 wt % to about 98 wt %, or about 75 wt % to about 98 wt %, or about 80 wt % to about 98 wt %, or about 85 wt % to about 98 wt %, or about 90 wt % to about 98 wt %, or about 50 wt % to about 95 wt %, or about 50 wt % to about 90 wt %, or about 50 wt % to about 85 wt %, or about 60 wt % to about 95 wt %, or about 60 wt % to about 90 wt %, or about 60 wt % to about 85 wt %, or about 60 wt % to about 80 wt %, or about 65 wt % to about 95 wt %, or about 65 wt % to about 90 wt %, or about 65 wt % to about 85 wt %, or about 65 wt % to about 80 wt %.

The blowing agent can be present in an amount of about 0.25 wt % to about 45 wt %, based on the total weight of the components in the polyol premix composition, or about 0.25 wt % to about 40 wt %, or about 0.25 wt % to about 35 wt %, or about 0.25 wt % to about 30 wt %, about 0.25 wt % to about 25 wt %, or about 0.25 wt % to about 20 wt %, or about 0.25 wt % to about 15 wt %, or about 0.25 wt % to about 10 wt %, or about 0.25 wt % to about 5 wt %, or about 0.25 wt % to about 2 wt %, or about 1 wt % to about 50 wt %, or about 1 wt % to about 45 wt %, or about 1 wt % to about 40 wt %, or about 1 wt % to about 35 wt %, or about 1 wt % to about 30 wt %, about 1 wt % to about 25 wt %, or about 1 wt % to about 20 wt %, or about 1 wt % to about 15 wt %, or about 1 wt % to about 10 wt %, or about 1 wt % to about 5 wt %, or about 1 wt % to about 2 wt %, or about 5 wt % to about 50 wt %, or about 5 wt % to about 45 wt %, or about 5 wt % to about 40 wt %, or about 5 wt % to about 35 wt %, or about 5 wt % to about 30 wt %, about 5 wt % to about 25 wt %, or about 5 wt % to about 20 wt %, or about 5 wt % to about 15 wt %, or about 5 wt % to about 10 wt %, or about 10 wt % to about 40 wt %, or about 10 wt % to about 35 wt %, or about 10 wt % to about 30 wt %, about 10 wt % to about 25 wt %, or about 10 wt % to about 20 wt %, or about 10 wt % to about 15 wt %, or about 15 wt % to about 50 wt %, or about 15 wt % to about 45 wt %, or about 15 wt % to about 40 wt %, or about 15 wt % to about 35 wt %, or about 15 wt % to about 30 wt %, or about 15 wt % to about 25 wt %, or about 15 wt % to about 20 wt %, or about 20 wt % to about 50 wt %, or about 20 wt % to about 45 wt %, or about 20 wt % to about 40 wt %, or about 20 wt % to about 35 wt %, or about 20 wt % to about 30 wt %, or about 20 wt % to about 25 wt %.

The polyol premix composition can include a catalyst and a surfactant.

The polyol premix composition can include one or more of: a flame retardant, a dye, a filler, a pigment, a dispersing agent, a cell stabilizer, and a nucleating agent.

The polyol premix composition can be formed by combining polyester polyol; halogenated olefin blowing agent, and compatibilizer. The blowing agent or the polyester polyol or both are substantially uniformly distributed in the compatibilizer, preferably by forming a stable solution, dispersion and/or emulsion of the compatibilizer, blowing agent and/or polyol.

In general, it is contemplated that the order and manner of the addition of the components in the compatibilizer blend and in the formation of the polyol premix can vary widely within the scope of the present invention. The compatibilizer can be added to the blowing agent before it is added to the remaining components of the premix composition. Alternatively, the compatibilizer can be added to the polyester polyol prior to addition of remaining components of the premix composition. Alternatively, the compatibilizer could be added to a mixture of the blowing agent, the polyester polyol, and any other components. Alternatively, all of the components could be added at the same time.

The polyester polyol may comprise one or more polyester polyols. A wide variety of polyester polyols can be used. Suitable polyester polyols include, but are not limited to, aromatic polyester polyols, aromatic polyethylene terephthalate polyols, aromatic carboxylic anhydrides, linear poly(diethylene adipate) glycol based polyester polyols, dipropylene glycol, and combinations thereof.

In addition to the polyester polyol(s), there can be one or more additional polyols. The additional polyol can be any polyol which reacts in a known fashion with an isocyanate in preparing a polyurethane or polyisocyanurate foam. Useful additional polyols comprise one or more of: a sucrose containing polyol; a phenol formaldehyde containing polyol; a glucose containing polyol; a sorbitol containing polyol; a methylglucoside containing polyol; toluene diamine containing polyol; Mannich base polyol; glycerol containing polyol; ethylene glycol containing polyol; diethylene glycol containing polyol; propylene glycol containing polyol; graft copolymers of polyether polyols with a vinyl polymer; a copolymer of a polyether polyol with a polyurea; one or more of (a) condensed with one or more of (b):
(a) glycerine, ethylene glycol, diethylene glycol, trimethylolpropane, ethylene diamine, pentaerythritol, soy oil, lecithin, tall oil, palm oil, castor oil;
(b) ethylene oxide, propylene oxide, butylene oxide, a mixture of ethylene oxide and propylene oxide; or combinations thereof.

When a mixture of polyester polyol(s) and one or more additional polyols is used, the polyester polyol (total amount of all polyester polyols) is generally present in an amount of about 1 wt. % to about 99 wt % of the total amount of polyol (polyester polyol(s) and additional polyol) and the additional polyol is generally present in an amount of about 1 wt. % to 99 wt % of the total amount of polyol. The polyester polyol can be present in an amount of about 5 wt % to about 99 wt % of the polyol premix composition, or about 10 wt % to about 99 wt %, or about 15 wt % to about 99 wt %, or about 20 wt % to about 99 wt %, or about 25 wt % to about 99 wt %, or about 30 wt % to about 99 wt %, or about 35 wt % to about 99 wt %, or about 40 wt % to about 99 wt %, or about 45 wt % to about 99 wt %, or about 50 wt % to about 99 wt %, or about 55 wt % to about 99 wt %, or about 60 wt % to about 99 wt %, or about 65 wt % to about 99 wt %, or about 70 wt % to about 99 wt %, or about 75 wt % to about 99 wt %, or about 80 wt % to about 99 wt %, or about 85 wt % to about 99 wt %, or about 90 wt % to about 99 wt %, or about 95 wt % to about 99 wt %, or about 5 wt % to about 95 wt %, or about 10 wt % to about 95 wt %, or about 15 wt % to about 95 wt %, or about 20 wt % to about 95 wt %, or about 25 wt % to about 95 wt %, or about 30 wt % to about 95 wt %, or about 35 wt % to about 95 wt %, or about 40 wt % to about 95 wt %, or about 45 wt % to about 95 wt %, or about 50 wt % to about 95 wt %, or about 55 wt % to about 95 wt %, or about 60 wt % to about 95 wt %, or about 65 wt % to about 95 wt %, or about 70 wt % to about 95 wt %, or about 75 wt % to about 95 wt %, or about 80 wt % to about 95 wt %, or about 85 wt % to about 95 wt %, or about 90 wt % to about 95 wt %, or about 5 wt % to about 90 wt %, or about 10 wt % to about 90 wt %, or about 15 wt % to about 90 wt %, or about 20 wt % to about 90 wt %, or about 25 wt % to about 90 wt %, or about 30 wt % to about 90 wt %, or about 35 wt % to about 90 wt %, or about 40 wt % to about 90 wt %, or about 45 wt % to about 90 wt %, or about 50 wt % to about 90 wt %, or about 55 wt % to about 90 wt %, or about 60 wt % to about 90 wt %, or about 65 wt % to about 90 wt %, or about 70 wt % to about 90 wt %, or about 75 wt % to about 90 wt %, or about 80 wt % to about 90 wt %, or about 85 wt % to about 90 wt %, or about 5 wt % to about 85 wt %, or about 10 wt % to about 85 wt %, or about 15 wt % to about 85 wt %, or 20 wt % to about 85 wt %, or about 25 wt % to about 85 wt %, or about 30 wt % to about 85 wt %, or about 35 wt % to about 85 wt %, or about 40 wt % to about 85 wt %, or about 45 wt % to about 85 wt %, or about 50 wt % to about 85 wt %, or about 55 wt % to about 85 wt %, or about 60 wt % to about 85 wt %, or about 65 wt % to about 85 wt %, or about 70 wt % to about 85 wt %, or about 75 wt % to about 85 wt %, or about 80 wt % to about 85 wt %, or about 85 wt % to about 85 wt %, or about 90 wt % to about 85 wt %, or about 5 wt % to about 80 wt %, or about 10 wt % to about 80 wt %, or about 15 wt % to about 80 wt %, or about 20 wt % to about 80 wt %, or about 25 wt % to about 80 wt %, or about 30 wt % to about 80 wt %, or about 35 wt % to about 80 wt %, or about 40 wt % to about 80 wt %, or about 45 wt % to about 80 wt %, or about 50 wt % to about 80 wt %, or about 55 wt % to about 80 wt %, or about 60 wt % to about 80 wt %, or about 65 wt % to about 80 wt %, or about 70 wt % to about 80 wt %, or about 75 wt % to about 80 wt, or about 5 wt % to about 75 wt %, or about 10 wt % to about 75 wt %, or about 15 wt % to about 75 wt %, or about 20 wt % to about 75 wt %, or about 25 wt % to about 75 wt %, or about 30 wt % to about 75 wt %, or about 35 wt % to about 75 wt %, or about 40 wt % to about 75 wt %, or about 45 wt % to about 75 wt %, or about 50 wt % to about 75 wt %, or about 55 wt % to about 75 wt %, or about 60 wt % to about 75 wt %, or about 65 wt % to about 75 wt %, or about 70 wt % to about 75 wt %, or about 5 wt % to about 70 wt %, or about 10 wt % to about 70 wt %, or about 15 wt % to about 70 wt %, or about 20 wt % to about 70 wt %, or about 25 wt % to about 70 wt %, or about 30 wt % to about 70 wt %, or about 35 wt % to about 70 wt %, or about 40 wt % to about 70 wt %, or about 45 wt % to about 70 wt %, or about 50 wt % to about 70 wt %, or about 55 wt % to about 70 wt %, or about 60 wt % to about 70 wt %, or about 65 wt % to about 70 wt %, or about 5 wt % to about 65 wt %, or about 10 wt % to about 65 wt %, or about 15 wt % to about 65 wt %, or about 20 wt % to about 65 wt %, or about 25 wt % to about 65 wt %, or about 30 wt % to about 65 wt %, or about 35 wt % to about 65 wt %, or about 40 wt % to about 65 wt %, or about 45 wt % to about 65 wt %, or about 50 wt % to about 65 wt %, or about 55 wt % to about 65 wt %, or about 60 wt % to about 65 wt, or 5 wt % to about 60 wt %, or about 10 wt % to about 60 wt %, or about 15 wt % to about 60 wt %, or about 20 wt % to about 60 wt %, or about 25 wt % to about 60 wt %, or about 30 wt % to about 60 wt %, or about 35 wt % to about 60 wt %, or about 40 wt % to about 60 wt %, or about 45 wt % to about 60 wt %, or about 50 wt % to about 60 wt %, or about 55 wt % to about 60 wt, or about 5 wt % to about 55 wt %, or about 10 wt % to about 55 wt %, or about 15 wt % to about 55 wt %, or about 20 wt % to about 55 wt %, or about 25 wt % to about 55 wt %, or about 30 wt % to about 55 wt %, or about 35 wt % to about 55 wt %, or about 40 wt % to about 55 wt %, or about 45 wt % to about 55 wt %, or about 50 wt % to 55 wt, or about 5 wt % to about 50 wt %, or about 10 wt % to about 50 wt %, or about 15 wt % to about 50 wt %, or about 20 wt % to about 50 wt %, or about 25 wt % to about 50 wt %, or about 30 wt % to about 50 wt %, or about 35 wt % to about 50 wt %, or about 40 wt % to about 50 wt %, or about 45 wt % to about 50 wt %. The polyester polyol comprises at least about 20% by weight, more preferably at least about 50% by weight, of the polyol in the blend. The remainder of the total polyol would be the additional polyol.

The amount and composition of the polyol used depends in part on the type of foam being made. Flexible foam can, for example, contain about 80 wt % to about 95 wt % of total polyol (polyester polyol and additional polyol (if any)) by weight of the polyol premix composition. In a spray foam, there can, for example, be about 65 wt % to about 85 wt % of total polyol by weight of the polyol premix composition. For appliance foam, there can, for example, be about 65 wt % to about 85 wt % of total polyol by weight of the polyol premix composition. For polyurethane (PUR) panel foam, there can, for example, be about 65 wt % to about 80 wt % of total polyol by weight of the polyol premix composition. For polyisocyanurate (PIR) panel foam, there can, for example, be about 65 wt % to about 85 wt % of total polyol by weight of the polyol premix composition. The PIR panel foam can, for example, be substantially all polyester polyol.

The halogenated olefin blowing agent preferably comprises C3 or C4 halogenated olefin, and even more preferably comprises cis-1,1,1,4,4,4-hexafluorobut-2-ene (cis-HFO-1336mzzm(Z)).

An auxiliary blowing agent can be present. Suitable auxiliary blowing agents include, but are not limited to, other hydrohaloolefins, fluorocarbons, chlorocarbons, chlorofluorocarbons, hydrocarbons, ethers, esters, aldehydes, ketones, acetals, organic acids, atmospheric gases, gas generating materials, or combinations thereof. By gas generating materials, we mean a material that generates gas, for example CO2, through decomposition or chemical reaction. Examples of gas generating materials include, but are not limited to, water, formic acid, or azodicarbonamide. Water reacts with the isocyanate to form carbon dioxide. Formic acid reacts with isocyanate to form carbon dioxide and carbon monoxide.

The other hydrohaloolefin suitably comprises at least one haloalkene such as a fluoroalkene or chloroalkene containing from 3 to 4 carbon atoms and at least one carbon-carbon double bond. Suitable hydrohaloolefins non-exclusively include: trifluoropropenes; tetrafluoropropenes, such as trans-HFO-1234ze or cis-HFO-1234ze; pentafluoropropenes such as HFO-1225; hexafluorobutenes, such as or trans-HFO-1336mzz chlorotrifluoropropenes such as trans-HFO-1233zd, cis-HFO-1233zd, HFO-1233xf; chlorodifluoropropenes; chlorotetrafluoropropenes, and combinations of these. Tetrafluoropropene, pentafluoropropene, and chlorotrifluoropropene compounds in which the unsaturated terminal carbon has not more than one F or Cl substituent are suitable. Included are trans-1,3,3,3-tetrafluoropropene (HFO-1234ze); 2,3,3,3-tetrafluoropropene (HFO-1234yf); 1,1,3,3-tetrafluoropropene; cis-1,2,3,3,3-pentafluoropropene (HFO-1225ye); trans-1,2,3,3,3-pentafluoropropene (HFO-1225ye); 1,1,1-trifluoropropene; 1,1,1,3,3-pentafluoropropene (HFO-1225zc); 1,1,1,3,3,3-hexafluorobut-2-ene, 1,1,2,3,3-pentafluoropropene (HFO-1225yc); cis-1,1,1,2,3-pentafluoropropene (HFO-1225ye); trans-1-chloro-3,3,3-trifluoropropene (HFO-1233zd); 2-chloro-3,3,3-trifluoropropene (HFO-1233xf); trans-1,1,1,4,4,4-hexafluorobut-2-ene (HFO-1336mzz), or combinations thereof, and any and all structural isomers, geometric isomers, or stereoisomers of each of these.

Preferred hydrohaloolefins have a Global Warming Potential (GWP) of not greater than 150, more preferably not greater than 100 and even more preferably not greater than 75. As used herein, “GWP” is measured relative to that of carbon dioxide and over a 100-year time horizon, as defined in “The Scientific Assessment of Ozone Depletion, 2002, a report of the World Meteorological Association's Global Ozone Research and Monitoring Project,” which is incorporated herein by reference. Preferred hydrohaloolefins also preferably have an Ozone Depletion Potential (ODP) of not greater than 0.05, more preferably not greater than 0.02 and even more preferably about zero. As used herein, “ODP” is as defined in “The Scientific Assessment of Ozone Depletion, 2002, A report of the World Meteorological Association's Global Ozone Research and Monitoring Project,” which is incorporated herein by reference.

Other suitable blowing agents include HCFC-141b (CH3CCl2F), HCFC-142b (CH3CClF2), HCFC-22 (CHClF2), HFC-245fa (CHF2CH2CF3), HFC-365mfc (CH3CF2CH2CF3), HFC-227ea (CF3CHFCF3), HFC-134a (CH2FCF3), HFC-152a (CH3CHF2), trans-1,2-dichloroethylene, propane, butane, isobutane, normal pentane, isopentane, cyclopentane, dimethyl ether, methyl formate, methyl acetate, acetone, methylal, ethylal, carbon dioxide, water, formic acid, acetic acid, and mixtures or two or more of these.

The blowing agent according to the present invention may be present across a range of concentrations based on the type and/or application of the foam, and all such concentrations are within the scope of the present invention. The blowing agent is present in the polyol premix composition, for example, in an amount of about 0.25 wt % to about 50 wt % of the polyol premix composition, or about 0.5 wt % to about 50 wt %, or about 1 wt % to about 50 wt %, or about 2 wt % to about 50 wt %, or about 0.5 wt % to about 40 wt %, or about 1 wt % to about 40 wt %, or about 2 wt % to about 40 wt %, or about 0.5 wt % to about 30 wt %, or about 1 wt % to about 30 wt %, or about 2 wt % to about 30 wt %, or about 0.5 wt % to about 25 wt %, or about 1 wt % to about 25 wt %, or about 2 wt % to about 25 wt %%, or about 0.5 wt % to about 20 wt %, or about 1 wt % to about 20 wt %, or about 2 wt % to about 20 wt %, or about 0.5 wt % to about 15 wt %, or about 1 wt % to about 15 wt %, or about 2 wt % to about 15 wt %%, or about 0.5 wt % to about 10 wt %, or about 1 wt % to about 10 wt %, or about 2 wt % to about 10 wt %.

Those skilled in the art, based on the teachings contained herein, will be able to select the amount of blowing agent to be used for the type of foam being made. For example, flexible foam generally will use a relatively low concentration of blowing agent, preferably HFO-1336mzzm(Z), and preferably in an amount of from about 0.25 wt % to about 10 wt %, or 0.5 wt % to about 8 wt %, or about 0.5 wt % to about 6 wt %, or about 0.5 wt % to about 5 wt %, or about 0.5 wt % to about 4 wt %. Spray foam preferably includes a blowing agent, preferably HFO-1336mzzm(Z), and preferably in an amount of from about 4 wt % to about 25 wt %, or about 4 wt % to about 20 wt %, or about 4 wt % to about 15 wt %, or about 6 wt % to about 12 wt %. Appliance foam, PIR panel foam, and PUR panel foam preferably include a blowing agent, preferably HFO-1336mzzm(Z), and preferably in an amount of from about 5 wt % to about 30 wt %, or about 10 wt % to about 30 wt %, or about 15 wt % to about 30 wt %.

When both HFO-1336mzzm(Z) and an auxiliary blowing agent are present, the HFO-1336mzzm(Z) is preferably present in an amount of about 1 wt % to about 99 wt % by weight of the total blowing agent, or about 5 wt % to about 99 wt %, or about 10 wt % to about 99 wt %, or about 15 wt % to about 99 wt %, or about 20 wt % to about 99 wt %, or about 25 wt % to about 99 wt %, or about 30 wt % to about 99 wt %, or about 35 wt % to about 99 wt %, or about 40 wt % to about 99 wt %, or about 45 wt % to about 99 wt %, or about 50 wt % to about 99 wt %, or about 55 wt % to about 99 wt %, or 60 wt % to about 99 wt %, or about 65 wt % to about 99 wt %, or about 70 wt % to about 99 wt %, or about 75 wt % to about 99 wt %, or about 80 wt % to about 99 wt %, or about 85 wt % to about 99 wt %, or about 90 wt % to about 99 wt %; and the auxiliary blowing agent is preferably present in an amount of about 99 wt % to about 1 wt % by weight of the total blowing agent, or about 95 wt % to about 1 wt %, or about 90 wt % to about 1 wt %, or about 85 wt % to about 1 wt %, or about 80 wt % to about 1 wt %, or about 75 wt % to about 1 wt %, or about 70 wt % to about 1 wt %, or about 65 wt % to about 1 wt %, or about 60 wt % to about 1 wt %, or about 55 wt % to about 1 wt %, or about 50 wt % to about 1 wt %, or about 45 wt % to about 1 wt %, or about 40 wt % to about 1 wt %, or about 35 wt % to about 1 wt %, or about 30 wt % to about 1 wt %, or about 25 wt % to about 1 wt %, or about 20 wt % to about 1 wt %, or about 15 wt % to about 1 wt %, or about 10 wt % to about 1 wt %.

The overall composition of the blend of blowing agents can vary widely within the broad scope of the present invention, and those skilled in the art will, based on the teachings contained herein, be able to tailor the specific blowing agent components and amounts to their particular needs, including based on the type of foam being made and the desired foam properties.

The polyol premix composition may contain a surfactant. The surfactant is used to form a foam from the mixture, as well as to control the size of the bubbles (cells) of the foam so that a foam of a desired cell structure is obtained. Preferably, a foam with small bubbles or cells therein of uniform size is desired since it has the most desirable physical properties such as compressive strength and thermal conductivity. Also, the foam should have stable cells which do not collapse prior to forming or during foam rise.

Suitable surfactants include silicone surfactants and non-silicone surfactants. The surfactant component is preferably present in the polyol premix composition in an amount of about 0.1 wt % to about 10 wt %, or about 0.2 wt % to about 5 wt %, or about 0.2 wt % to about 3.0 wt %, or about 0.5 wt % to about 3.0 wt % by weight of the polyol premix composition.

The polyol premix composition contains a catalyst. Suitable catalysts include amine catalysts and non-amine catalysts. The catalyst is preferably present in the polyol premix composition in an amount of about 0.2 wt % to about 8.0 wt %, or about 0.4 wt % to about 7.0 wt %, or about 0.5 wt % to about 6.0 wt %, by weight of the polyol premix composition.

Conventional flame retardants can optionally be incorporated, preferably in an amount of not more than about 20 wt % of the polyol premix, or not more than about 15 wt %, or not more than about 10 wt %. Some embodiments, such as appliance foam, typically do not contain any flame retardant. Optional flame retardants include, but are not limited to, tris(2-chloroethyl)phosphate, tris(2-chloropropyl)phosphate, tris(2,3-dibromopropyl)phosphate, tris(3-dichloropropyl)phosphate, tri(2-chloroisopropyl)phosphate, tricresyl phosphate, tri(2,2-dichloroisopropyl)phosphate, diethyl N,N-bis(2-hydroxyethyl) aminomethylphosphonate, dimethyl methylphosphonate, tri(2,3-dibromopropyl)phosphate, tri(1,3-dichloropropyl)phosphate, and tetra-cis-(2-chloroethyl)ethylene diphosphate, triethylphosphate, diammonium phosphate, various halogenated aromatic compounds, antimony oxide, aluminum trihydrate, polyvinyl chloride, melamine, and the like.

In addition to the previously described ingredients, other ingredients such as, dyes, fillers, pigments, dispersing agents, cell stabilizers, nucleating agents (such as 3M's perfluoro compounds, PF-5056 and FA-188), and the like can be included in the preparation of the foams. The other ingredients will typically be included in an amount up to a total of 20 wt % of the polyol premix composition, or not more than 15 wt %, or not more than 10 wt %, or not more than 5 wt %. Conventional fillers for use herein include, for example, aluminum silicate, calcium silicate, magnesium silicate, calcium carbonate, barium sulfate, calcium sulfate, glass fibers, carbon black and silica. A pigment which can be used herein can be any conventional pigment such as titanium dioxide, zinc oxide, iron oxide, antimony oxide, chrome green, chrome yellow, iron blue siennas, molybdate oranges and organic pigments such as para reds, benzidine yellow, toluidine red, toners and phthalocyanines.

The polyol premix composition may contain about 50 wt % to about 98 wt % of the polyester polyol and optional additional polyol. If the optional additional polyol is present, there can be about 10 wt % to about 99 wt % (based on total weight of polyol component) of a polyester polyol, and about 1 wt % to about 90 wt % (based on total weight of polyol component) of an additional polyol, such as, polyether polyols, and Mannich polyols. The polyol premix composition may contain about 0.25 wt % to about 50 wt % of a blowing agent (based on total polyol premix). The blowing agent can be HFO-1336mzzm(Z) or a mixture of HFO-1336mzzm(Z) and an auxiliary blowing agent. The HFO-1336mzzm(Z) can be present in an amount of about 40 wt % to about 99 wt %, by weight of the blowing agent component, and the auxiliary blowing agent can be present in an amount of 1 wt % to 60 wt %, by weight of the blowing agent component. The compatibilizer can be an alcohol and be present in an amount of about 0.01 wt % to about 10 wt %. There can be about 0.2 to about 5 wt % of a surfactant. The polyol premix composition can contain about 0.1 wt % to about 8.0 wt % of a catalyst. The polyol premix may contain up to about 20 wt % of flame retardant, and up to about 20 wt % of other additives.

A preferred formulation for foam used for appliances, PIR panels, and PUR panels comprises from about 65 wt % to about 85 wt % of polyester polyol and optional additional polyol based on total polyol premix composition (about 20 wt % to about 99 wt % polyester polyol and about 1 wt % to about 80 wt % additional polyol (if present) (based on total weight of polyol)). The polyol premix composition may contain about 15 wt % to about 30 wt % of a blowing agent (based on total polyol premix) (cis-HFO-1336mzzm(Z) or a mixture of about 92 wt % to about 97 wt % of cis-HFO-1336mzzm(Z) and about 3 wt % to about 8 wt % water). The compatibilizer can be an alcohol and be present in an amount of about 0.01 wt % to about 10 wt %. There can be about 0.2 to about 5 wt % of a surfactant, and about 0.1 wt % to about 6 wt % of a catalyst. The polyol premix composition may contain optionally about 15 wt % of flame retardant, and about 10 wt % of other additives.

A preferred formulation for spray foam application comprises about 65 wt % to about 85 wt % of polyester polyol and optional additional polyol based on total polyol premix composition (about 40 wt % to about 99 wt % polyester polyol and about 1 wt % to about 60 wt % additional polyol (if present) (based on total weight of polyol)). The polyol premix composition preferably in such embodiments contains about 6 wt % to about 12 wt % of a blowing agent (based on total polyol premix composition) (cis-HFO-1336mzzm(Z) or a mixture of about 60 wt % to about 85 wt % of cis-HFO-1336mzzm(Z) and about 15 wt % to about 40 wt % water). The compatibilizer can be an alcohol and be present in an amount of about 0.01 wt % to about 10 wt %. There can be about 0.2 to about 5 wt % of a surfactant, about 0.1 wt % to about 8 wt % of a catalyst. The polyol premix composition may contain 15 wt % of flame retardant, and 10 wt % of other additives.

A preferred flexible foam formulation comprises from about 80 wt % to about 95 wt % of polyester polyol and optional additional polyol based on total polyol premix composition (about 10 wt % to about 99 wt % polyester polyol and about 1 wt % to about 90 wt % additional polyol (if present) (based on total weight of polyol)). The polyol premix composition may contain about 0.5 wt % to about 4 wt % of a blowing agent (based on total polyol premix composition) (cis-HFO-1336mzzm(Z) or a mixture of about 40 wt % to about 50 wt % of cis-HFO-1336mzzm(Z) and about 50 wt % to about 60 wt % water). The compatibilizer can be an alcohol and be present in an amount of about 0.01 wt % to about 10 wt %. There can be about 0.2 to about 5 wt % of a surfactant, and about 0.1 wt % to about 3.5 wt % of a catalyst. The polyol premix composition may contain about 10 wt % of flame retardant, and about 10 wt % of other additives.

Preferred distribution enhancing components for aromatic polyester polyol, and cis-HFO-1336mzzm(Z) include alcohols, alkylphenol ethoxylates, ethers, and chlorinated solvents.

One preferred polyol premix includes a mono-functional non-cyclic alcohol having 1 to 10 carbon atoms, more preferred, 1 to 5 carbon atoms, more preferred, 2 to 5 carbon atoms, more preferred, 2 to 4 carbon atoms, and even more preferred ethanol.

One preferred polyol premix includes an aromatic polyester polyol, cis-HFO-1336mzzm(Z), and nonylphenol ethyoxylate.

One preferred polyol premix includes an aromatic polyester polyol, cis-HFO-1336mzzm(Z), and ethylene glycol mono-butyl ether.

One preferred polyol premix includes an aromatic polyester polyol, cis-HFO-1336mzzm(Z), and 2-chloropropane.

Preferred distribution enhancing components for aromatic carboxylic anhydrides (phthalic) polyester polyol, and cis-HFO-1336mzzm(Z) include alcohols, alkylphenol ethoxylates, glycols, ethers and acetals, benzenes, ketones, chlorinated solvents, carbonates, and solvents.

One preferred polyol premix includes an aromatic carboxylic anhydrides (phthalic) polyester polyol, cis-HFO-1336mzzm(Z), and a mono-functional non-cyclic alcohol having 1 to 10 carbon atoms, more preferred, 1 to 5 carbon atoms, more preferred, 2 to 5 carbon atoms, more preferred, 2 to 4 carbon atoms, and even more preferred ethanol.

One preferred polyol premix includes an aromatic carboxylic anhydrides (phthalic) polyester polyol, cis-HFO-1336mzzm(Z), and nonylphenol ethoxylate.

One preferred polyol premix includes an aromatic carboxylic anhydrides (phthalic) polyester polyol, cis-HFO-1336mzzm(Z), and dipropylene glycol.

One preferred polyol premix includes an aromatic carboxylic anhydrides (phthalic) polyester polyol, cis-HFO-1336mzzm(Z), and dipropylene glycol methyl ether.

One preferred polyol premix includes an aromatic carboxylic anhydrides (phthalic) polyester polyol, cis-HFO-1336mzzm(Z), and methylal.

One preferred polyol premix includes an aromatic carboxylic anhydrides (phthalic) polyester polyol, cis-HFO-1336mzzm(Z), and ethylene glycol mono-butyl ether.

One preferred polyol premix includes an aromatic carboxylic anhydrides (phthalic) polyester polyol, cis-HFO-1336 mzzm(Z), and 1,3-diisopropenyl benzene.

One preferred polyol premix includes an aromatic carboxylic anhydrides (phthalic) polyester polyol, cis-HFO-1336mzzm(Z), and isopropenyl benzene.

One preferred polyol premix includes an aromatic carboxylic anhydrides (phthalic) polyester polyol, cis-HFO-1336mzzm(Z), and acetone.

One preferred polyol premix includes an aromatic carboxylic anhydrides (phthalic) polyester polyol, cis-HFO-1336mzzm(Z), and methyl ethyl ketone.

One preferred polyol premix includes an aromatic carboxylic anhydrides (phthalic) polyester polyol, cis-HFO-1336mzzm(Z), and methyl formate.

One preferred polyol premix includes an aromatic carboxylic anhydrides (phthalic) polyester polyol, cis-HFO-1336mzzm(Z), and trans-1,2-dichloro ethylene.

One preferred polyol premix includes an aromatic carboxylic anhydrides (phthalic) polyester polyol, cis-HFO-1336mzzm(Z), and 2-chloropropane.

One preferred polyol premix includes an aromatic carboxylic anhydrides (phthalic) polyester polyol, cis-HFO-1336mzzm(Z), and propylene carbonate.

One preferred polyol premix includes an aromatic carboxylic anhydrides (phthalic) polyester polyol, cis-HFO-1336mzzm(Z), and dioctyl phthalate.

One preferred polyol premix includes an aromatic carboxylic anhydrides (phthalic) polyester polyol, cis-HFO-1336mzzm(Z), and toluene.

One preferred polyol premix includes an aromatic carboxylic anhydrides (phthalic) polyester polyol, cis-HFO-1336mzzm(Z), and 1-propoxy-2-propanol.

Preferred distribution enhancing components for aromatic polyester polyol diols, and cis-HFO-1336mzzm(Z) include alcohols, glycols, and ethers.

One preferred polyol premix includes an aromatic polyester polyol diols, cis-HFO-1336mzzm(Z), and a mono-functional non-cyclic alcohol having 1 to 10 carbon atoms, more preferred, 1 to 5 carbon atoms, more preferred, 2 to 5 carbon atoms, more preferred, 2 to 4 carbon atoms, and even more preferred ethanol.

One preferred polyol premix includes an aromatic polyester polyol diols, cis-HFO-1336mzzm(Z), and ethylene glycol.

One preferred polyol premix includes an aromatic polyester polyol diols, cis-HFO-1336mzzm(Z), and ethylene glycol mono-butyl ether.

Preferred distribution enhancing components for aliphatic adipate diethylene glycol based polyester polyol, and cis-HFO-1336mzzm(Z) include alcohols, alkylphenol ethoxylates, ethers and acetals, benzenes, and ketones.

One preferred polyol premix includes a linear aliphatic adipate diethylene glycol based polyester polyol, cis-HFO-1336mzzm(Z), and a mono-functional non-cyclic alcohol having 1 to 10 carbon atoms, more preferred, 1 to 5 carbon atoms, more preferred, 2 to 5 carbon atoms, more preferred, 2 to 4 carbon atoms, and even more preferred ethanol.

One preferred polyol premix includes a linear aliphatic adipate diethylene glycol based polyester polyol, cis-HFO-1336mzzm(Z), and nonylphenol ethoxylate.

One preferred polyol premix includes a linear aliphatic adipate diethylene glycol based polyester polyol, cis-HFO-1336mzzm(Z), and dipropylene glycol methyl ether.

One preferred polyol premix includes a linear aliphatic adipate diethylene glycol based polyester polyol, cis-HFO-1336mzzm(Z), and methylal.

One preferred polyol premix includes a linear aliphatic adipate diethylene glycol based polyester polyol, cis-HFO-1336mzzm(Z), and ethylene glycol mono-butyl ether.

One preferred polyol premix includes a linear aliphatic adipate diethylene glycol based polyester polyol, cis-HFO-1336mzzm(Z), and isopropenyl benzene.

One preferred polyol premix includes a linear aliphatic adipate diethylene glycol based polyester polyol, cis-HFO-1336mzzm(Z), and acetone.

One preferred polyol premix includes a linear aliphatic adipate diethylene glycol based polyester polyol, cis-HFO-1336mzzm(Z), and methyl ethyl ketone.

One preferred polyol premix includes a linear aliphatic adipate diethylene glycol based polyester polyol, cis-HFO-1336mzzm(Z), and trans-1-chloro-3,3,3-trifluoropropene.

One preferred polyol premix includes a linear aliphatic adipate diethylene glycol based polyester polyol, cis-HFO-1336mzzm(Z), and methyl formate.

The preparation of polyurethane or polyisocyanurate foams using the compositions described herein may follow any of the methods well known in the art, see Saunders and Frisch, Volumes I and II Polyurethanes Chemistry and technology, 1962, John Wiley and Sons, New York, N.Y. or Gum, Reese, Ulrich, Reaction Polymers, 1992, Oxford University Press, New York, N.Y. or Klempner and Sendijarevic, Polymeric Foams and Foam Technology, 2004, Hanser Gardner Publications, Cincinnati, Ohio. In general, polyurethane or polyisocyanurate foams are prepared by combining an isocyanate, the polyol premix composition, and other materials such as optional flame retardants, colorants, or other additives. These foams can be rigid, flexible, or semi-rigid, and can have a closed cell structure, an open cell structure, or a mixture of open and closed cells.

It is convenient in many applications to provide the components for polyurethane or polyisocyanurate foams in pre-blended formulations. Most typically, the foam formulation is pre-blended into two components. The isocyanate and optionally other isocyanate compatible raw materials comprise the first component, commonly referred to as the “A” component. The polyol mixture composition, including surfactant, catalysts, blowing agents, and optional other ingredients comprise the second component, commonly referred to as the “B” component. In any given application, the “B” component may not contain all the above listed components; for example, some formulations omit the flame retardant if flame retardancy is not a required foam property. Accordingly, polyurethane or polyisocyanurate foams are readily prepared by bringing together the A and B side components either by hand mix for small preparations and, preferably, machine mix techniques to form blocks, slabs, laminates, pour-in-place panels and other items, spray applied foams, froths, and the like. Optionally, other ingredients such as fire retardants, colorants, auxiliary blowing agents, water, and even other polyols can be added as a stream to the mix head or reaction site. Most conveniently, however, they are all incorporated into one B component as described above.

A foamable composition suitable for forming a polyurethane or polyisocyanurate foam may be formed by reacting an organic polyisocyanate and the polyol premix composition described above. Any organic polyisocyanate can be employed in polyurethane or polyisocyanurate foam synthesis inclusive of aliphatic and aromatic polyisocyanates. Suitable organic polyisocyanates include aliphatic, cycloaliphatic, araliphatic, aromatic, and heterocyclic isocyanates which are well known in the field of polyurethane chemistry. These are described in, for example, U.S. Pat. Nos. 4,868,224; 3,401,190; 3,454,606; 3,277,138; 3,492,330; 3,001,973; 3,394,164; 3,124,605; and 3,201,372. Preferred as a class are the aromatic polyisocyanates.

Representative organic polyisocyanates correspond to the formula:

R(NCO)z
wherein R is an aliphatic group, an aromatic group, or mixtures thereof, and z is an integer which corresponds to the valence of R and is at least two. Representative of the organic polyisocyanates contemplated herein includes, for example, the aromatic diisocyanates such as 2,4-toluene diisocyanate, 2,6-toluene diisocyanate, mixtures of 2,4- and 2,6-toluene diisocyanate, crude toluene diisocyanate, methylene diphenyl diisocyanate, crude methylene diphenyl diisocyanate and the like; the aromatic triisocyanates such as 4,4′,4″-triphenylmethane triisocyanate, 2,4,6-toluene triisocyanates; the aromatic tetraisocyanates such as 4,4′-dimethyldiphenylmethane-2,2′5,5-′tetraisocyanate, and the like; arylalkyl polyisocyanates such as xylene diisocyanate; aliphatic polyisocyanate such as hexamethylene-1,6-diisocyanate, lysine diisocyanate methylester and the like; and mixtures thereof. Other organic polyisocyanates include polymethylene polyphenylisocyanate, hydrogenated methylene diphenylisocyanate, m-phenylene diisocyanate, naphthylene-1,5-diisocyanate, 1-methoxyphenylene-2,4-diisocyanate, 4,4′-biphenylene diisocyanate, 3,3′-dimethoxy-4,4′-biphenyl diisocyanate, 3,3′-dimethyl-4,4′-biphenyl diisocyanate, and 3,3′-dimethyldiphenylmethane-4,4′-diisocyanate; Typical aliphatic polyisocyanates are alkylene diisocyanates such as trimethylene diisocyanate, tetramethylene diisocyanate, and hexamethylene diisocyanate, isophorene diisocyanate, 4,4′-methylenebis(cyclohexyl isocyanate), and the like; typical aromatic polyisocyanates include m-, and p-phenylene diisocyanate, polymethylene polyphenyl isocyanate, 2,4- and 2,6-toluenediisocyanate, dianisidine diisocyanate, bitoylene isocyanate, 1,4-diisocyanate, bis(4-isocyanatophenyl)methene, bis(2-methyl-4-isocyanatophenyl)methane, and the like. Preferred polyisocyanates are the polymethylene polyphenyl isocyanates, particularly the mixtures containing about 30 to about 85 percent by weight of methylenebis(phenyl isocyanate) with the remainder of the mixture comprising the polymethylene polyphenyl polyisocyanates of functionality higher than 2. In certain cases, a so-called isocyanate prepolymer can also be used. The prepolymer is formed by combining an excess of diisocyanate with polyol (polyester polyol, or polyether polyol). These polyisocyanates are prepared by conventional methods known in the art. In the present invention, the polyisocyanate and the polyol are employed in amounts which will yield an NCO/OH stoichiometric ratio in a range of about 0.9 to about 5.0. In the present invention, the NCO/OH equivalent ratio is, preferably, about 0.9 to about 4, or about 0.95 to about 3. Suitable organic polyisocyanates include polymethylene polyphenyl isocyanate, methylene bis(phenyl isocyanate), toluene diisocyanates, or combinations thereof.

In the preparation of polyisocyanurate foams, trimerization catalysts are preferably used for the purpose of converting the blends in conjunction with excess A component to polyisocyanurate-polyurethane foams. The trimerization catalysts employed can be any catalyst known to one skilled in the art, including, but not limited to, glycine salts, tertiary amine trimerization catalysts, quaternary ammonium carboxylates, and alkali metal carboxylic acid salts and mixtures of the various types of catalysts. Preferred species within the classes are potassium acetate, potassium octoate, and N-(2-hydroxy-5-nonylphenol) methyl-N-methylglycinate.

The polyurethane or polyisocyanurate foams produced can vary in density from about 0.5 pounds per cubic foot to about 60 pounds per cubic foot, or about 0.5 to about 20.0 pounds per cubic foot, or about 0.5 to about 15 pounds per cubic foot. The density obtained is a function of how much of the blowing agent or blowing agent mixture plus the amount of auxiliary blowing agent, such as water or other co-blowing agents is present in the A and/or B components, or alternatively added at the time the foam is prepared. These foams can be rigid, flexible, or semi-rigid foams, and can have a closed cell structure, an open cell structure or a mixture of open and closed cells. These foams are used in a variety of well-known applications, including but not limited to thermal insulation, cushioning, flotation, packaging, adhesives, void filling, crafts and decorative, and shock absorption.

The following non-limiting examples serve to illustrate the invention.

### EXAMPLES

### Comparative Example 1: Distribution of Blowing Agent in Polyols

The ability of certain polyols to form stable, uniform distributions of HFO-1336mzzm(Z) but in the absence of the compatibilizer aspects of the present invention was tested. Each polyol identified in Table 1 was tested by placing a predetermined amount of the polyol into a 3-ounce glass pressure vessel, and the height and weight of the polyol were recorded. For each test, each liquid blowing agents identified in Table 1, including HFO-1336mzzm(Z), was then added in an amount to produce in the vessel 5% by weight of blowing agent and 95% by weight of the polyol, with the total weight of polyol and blowing agent in the vessel being 70 grams. The tube assembly was sealed, and the height and weight of the polyol plus blowing agent components together were recorded. The components were then mixed well in an effort to obtain a homogenous distribution of blowing agent in the polyol. The height of the liquid and a visual observation of the condition of the mixture of components were recorded for the test temperature. If a homogeneous mixture was produced, that is, the blowing agent at a concentration of 5% by weight was uniformly distributed by visual observation in the polyol, this result was recorded in the column of Table 2 entitled “Wt % Uniform Distribution” as 5 wt %. If for any test the sample did not exhibit the existence of a visually homogeneous mixture, that is, phase separation was observed, the height of each layer was recorded and based on this height and known density information for the polyol and blowing agent, the amount of blowing agent uniformly distributed in the polyol, on a wt % basis, was reported. The test was performed at room temperature (RT), 32° C. (90° F.), and 54° C. (130° F.).

Table 1 shows the blowing agents, blowing agent concentrations, and polyols tested.

TABLE 1

| Blowing | | |
|---|---|---|
| Agent | Polyol | Polyol Description |
| HFC- | Polyol A | Glycerin and propylene oxide based polyether |
| 245fa, | | polyol triol with an ethylene oxide cap with |
| HFO- | | molecular weight of 6000 g/mol and hydroxyl |
| 1233zd(E), | | number of 26.5-28.5 |
| HFO- | Polyol B | Glycerin and propylene oxide based polyether |
| 1336mzzm | | polyol triol with an ethylene oxide cap with a |
| (Z) | | molecular weight of 4800 g/mol and hydroxyl |
| | | number 35 |
| | Polyol C | Dipropylene Glycol Chain Extender Diol |
| | Polyol D | 1,4,Butane Diol Chain Extender Diol |
| | Polyol E | Polyether triol with hydroxyl number of 648 |
| | | (low MW) |

TABLE 2
Polyol Distribution Tested to 5 wt %

| | | Wt % | | Wt % Uniform |
|---|---|---|---|---|
| | | Uniform | Wt % Uniform | distribution, |
| | | distribution, | distribution, | 54° C. |
| Polyol | Blowing Agent | RT | 32° C. (90° F.) | (130° F.) |
| A | HFC-245fa | 5 | 5 | 5 |
| B | | 5 | 5 | 5 |
| C | | 5 | 5 | 5 |
| D | | 0 | 0 | 2.5 |
| E | | 5 | 5 | 5 |
| A | HFO- | 5 | 5 | 5 |
| B | 1233zd(E) | 5 | 5 | 5 |
| C | | 5 | 5 | 5 |
| D | | 0 | 2.5 | 5 |
| E | | 5 | 5 | 5 |
| A | HFO- | 5 | 5 | 5 |
| B | 1336mzzm(Z) | 5 | 5 | 5 |
| C | | 5 | 5 | 5 |
| D | | 0 | 0 | 2.0 |
| E | | 5 | 5 | 5 |

As can be seen from Table 2 above, polyol D (1,4 Butane Diol Chain Extender Diol) was not able to form a homogeneous mixture with HFO-1336mzzm(Z) at any concentration for the room temperature test and the 32° C. test. Even at the elevated temperature of 54° C., the maximum amount of HFO-1336mzzm(Z) that could be uniformly distributed in the polyol D was only 2%. In contrast, the other polyols were able to form, even in the absence of a compatibilizer, a uniform distribution in amounts of about 5% by weight of HFO-1336mzzm(Z). In general, the ability to achieve a uniform distribution of all the blowing agents tested improved with higher temperature.

The testing was repeated with other polyols. Each polyol identified in Table 3 was tested by adding each liquid blowing agent identified in Table 3, including HFO-1336mzzm(Z), in an amount to produce in the vessel 21% by weight of blowing agent and 79% by weight of the polyol, with the total weight of polyol and blowing agent in the vessel being 70 grams. If a homogeneous mixture was produced, that is, the blowing agent at a concentration of 21% by weight was uniformly distributed by visual observation in the polyol, this result was recorded in the column of Table 4 entitled “Wt % Uniform Distribution” as 21 wt %. If for any test, the sample did not exhibit the existence of a visually homogeneous mixture, that is, phase separation was observed, the height of each layer was recorded and based on this height and known density information for the polyol and blowing agent, the amount of blowing agent uniformly distributed in the polyol, on a wt % basis, was reported. The test was performed at room temperature (RT), 32° C. (90° F.), and 54° C. (130° F.).

TABLE 3

| Blowing | | |
|---|---|---|
| Agent | Polyol | Polyol Description |
| HFC- | Polyol F | Aromatic carboxylic anhydrides (phthalic) |
| 245fa, | | polyester polyol |
| HFO- | | with hydroxyl number 240 |
| 1233zd(E), | Polyol G | Aromatic polyester polyol |
| HFO- | Polyol H | Aromatic polyester polyol with hydroxyl |
| 1336mzzm | | number 235 |
| (Z) | Polyol I | Aromatic polyester polyol |
| | Polyol K | Mannich based polyol with hydroxyl number |
| | | of 470 |
| | Polyol L | Sucrose/glycerin polyether initiated polyol |
| | | with hydroxyl number of 360 |
| | Polyol M | Sucrose/glycerin initiated polyether polyol |
| | | with hydroxyl number of 490 |
| | Polyol N | Aliphatic Amine initiated polyester polyol with |
| | | hydroxyl number of 635 |
| | Polyol O | Aromatic polyester polyol with hydroxyl |
| | | number of 360-380 |

Table 4 below shows the blowing agents, blowing agent concentrations, and polyols tested.

TABLE 4
Polyol Distributions Tested to 21 wt. %

| | | | Wt % | |
|---|---|---|---|---|
| | | Wt % | Uniform | Wt % |
| | | Uniform | Distribution, | Uniform |
| | Blowing | Distribution | 32° C. | Distribution, |
| Polyol | Agent | RT | (90° F.) | 54° C. (130° F.) |
| F | HFC-245fa | 21 | 21 | 21 |
| G | | 0 | 0 | 0 |
| H | | 16.6 | 17.7 | 17.9 |
| I | | 0 | 0 | 0 |
| F | HFO- | 21 | 21 | 21 |
| G | 1233zd(E) | 4.2 | 21 | 11.5 |
| H | | 21 | 21 | 21 |
| I | | 4.2 | 21 | 12.4 |
| F | HFO- | 8.8 | 7.7 | 7 |
| G | 1336mzzm(Z) | 0 | 0 | 0 |
| H | | 3.3 | 4 | 5 |
| I | | 0 | 0 | 1 |
| K | HFC-245fa | 21 | 21 | 21 |
| L | | 21 | 21 | 21 |
| M | | 21 | 21 | 21 |
| N | | 21 | 21 | 21 |
| O | | 8 | 7 | 8 |
| K | HFO- | 21 | 21 | 21 |
| L | 1233zd(E) | 21 | 21 | 21 |
| M | | 21 | 21 | 21 |
| N | | 21 | 21 | 21 |
| O | | 21 | 21 | 21 |
| K | HFO- | 21 | 21 | 21 |
| L | 1336mzzm(Z) | 21 | 21 | 21 |
| M | | 21 | 21 | 21 |
| N | | 21 | 21 | 21 |
| O | | 0 | 0 | 0 |

In the absence of the present invention, HFO-1336mzzm(Z) had significantly lower levels of uniform distribution in polyols F-I at all temperatures than HFO-1233zd(E). HFO-1233zd(E) had superior uniformity of distribution in polyols F-I compared to HFO-1336mzzm(Z) and HFC-245fa.

In the absence of the present invention, HFO-1336mzzm(Z) had significantly lower level of uniform distribution in Polyol 0 at all temperatures than HFO-1233zd(E). HFO-1233zd(E) had superior uniformity of distribution in polyols K-O compared to HFO-1336mzzm(Z) and HFC-245fa.

From this testing, it appeared that HFO-1336mzzm(Z) had significantly lower level of uniform distribution certain polyester polyols, but that polyether polyols did not have a similar problem.

### Example 1: Compatibilizers for Use with HFO-1336mzzm(Z)

A study was undertaken to determine the extent to which certain compatibilizers were able to increase the ability of HFO-1336mzzm(Z) to be uniformly distributed in different classes of polyester polyols, specifically aromatic carboxylic anhydrides (phthalic) polyester polyols (Polyol F), aromatic polyester polyols (Polyol 0), aromatic polyester polyol diols (Polyol P), and linear aliphatic adipate diethylene glycol based polyester polyols (Polyol Q).

A first set of tests was performed to demonstrate the ability of various distribution agents to be uniformly distributed in the tested polyol. Seventeen (17) grams of each polyol tested was transferred to a small vial, and the height of the polyol was recorded. Eight (8) grams of the appropriate weight of the identified compatibilizer was added to the polyol, and it was reported whether a uniform distribution was formed upon mixing.

A second set of tests was performed to demonstrate the ability of various distribution agents to be uniformly distributed in the blowing agent HFO-1336mzzm (Z). Eight and a half (8.5) grams of the blowing agent was transferred to a small vial, and the height of the blowing agent is recorded. One and half (1.5) grams of the identified compatibilizer was added to the blowing agent, and it was reported whether a uniform distribution was formed upon mixing.

A third set of tests was performed to demonstrate the ability of various distribution agents to be uniformly distributed together with the blowing agent HFO-1336mzzm (Z) and the tested polyols. The mixtures as indicated in the first test and the second test were repeated as indicated above, and then 16 grams of the first mixture (the polyol/compatibilizer mixture) and 4 grams of the second mixture (the HFO-1336mzzm (Z)/compatibilizer mixture) were mixed to form a mixture of the polyol, the HFO-1336mzzm (Z), and the indicated compatibilizer (UDA). The formation or not of a uniform distribution of the blowing agent and polyol and compatibilizer was reported by visual observation upon mixing. For the purposes of convenience, the uniform distribution agents are identified in the Tables 5A-5F as UDA.

TABLE 5A
Alcohols

| | | Polyol | | | | | | | |
|---|---|---|---|---|---|---|---|---|---|
| | | O | | F | | P | | Q | |
| | | Type | | | | | | | |
| | | | | Aromatic | | | | Linear Aliphatic | |
| | | | | carboxylic | | | | Adipate | |
| | | Aromatic | | anhydrides | | Aromatic | | Diethylene | |
| | | polyester | | (phthalic) | | polyester | | Glycol based | |
| | | Polyol | | polyester polyol | | polyol Diols | | polyester polyol | |
| | hydroxyl # | | | | | | | | |
| | 1336 | 360-380 | | 240 | | 295-315 | | 54-58 | |
| | UDA | | | | | | | | |
| | | | 1336 + | | 1336 + | | 1336 + | | 1336 + |
| | 1336 + | polyol + | polyol + | polyol + | polyol + | polyol + | polyol + | polyol + | polyol + |
| Alcohols | UDA | UDA | UDA | UDA | UDA | UDA | UDA | UDA | UDA |
| Ethanol | yes¹ | yes | yes | yes | yes | yes | yes | yes | yes |
| Methanol | yes | yes | yes | yes | yes | yes | yes | yes | yes |
| isopropanol | yes | yes | yes | yes | yes | yes | yes | yes | yes |
| n-butanol | yes | yes | yes | yes | yes | yes | yes | yes | yes |
| 2-propanol | yes | yes | yes | yes | yes | yes | yes | yes | yes |
| 1 pentanol | yes | yes | yes | yes | yes | no² | —³ | no | — |
| 3 methyl 2 | yes | yes | yes | yes | yes | no | — | yes | yes |
| butanol | | | | | | | | | |
| 2 methyl 1 | yes | yes | yes | yes | yes | no | — | no | — |
| propanol | | | | | | | | | |
| Nonylphenol | yes | yes | yes | yes | yes | no | — | yes | yes |
| Ethoxylate | | | | | | | | | |

¹yes means 100% uniform distribution, uniform solution
²no means <100% uniform distribution, layer or cloudy in appearance
³Tests not conducted since binary material is not uniformly distributed

TABLE 5B
Glycols and Ethers

| | Polyol | | | | | | | |
|---|---|---|---|---|---|---|---|---|
| | O | | F | | P | | Q | |
| | Type | | | | | | | |
| | | | Aromatic | | | | Linear Aliphatic | |
| | | | carboxylic | | | | Adipate | |
| | Aromatic | | anhydrides | | Aromatic | | Diethylene | |
| | polyester | | (phthalic) | | polyester polyol | | Glycol based | |
| | Polyol | | polyester polyol | | Diols | | polyester polyol | |
| hydroxyl # | | | | | | | | |
| 1336 | 360-380 | | 240 | | 295-315 | | 54-58 | |
| UDA | | | | | | | | |
| | | 1336 + | | 1336 + | | 1336 + | | 1336 + |
| 1336 + | polyol + | polyol + | polyol + | polyol + | polyol + | polyol + | polyol + | polyol + |
| UDA | UDA | UDA | UDA | UDA | UDA | UDA | UDA | UDA |

Glycols

| | | | | | | | | | |
|---|---|---|---|---|---|---|---|---|---|
| ethylene glycol | no² | no | —³ | yes¹ | No | yes | Yes | no | — |
| diethylene glycol | no | no | — | yes | — | no | — | no | — |
| Propylene Glycol | no | no | — | no | — | no | — | no | — |
| Dipropylene | yes | no | — | yes | yes | no | — | no | — |
| Glycol | | | | | | | | | |

Ethers/Acetals

| | | | | | | | | | |
|---|---|---|---|---|---|---|---|---|---|
| dipropylene | yes | no | — | yes | Yes | no | — | yes | yes |
| glycol methyl | | | | | | | | | |
| ether | | | | | | | | | |
| methylal | yes | yes | no | yes | Yes | yes | No | yes | yes |
| Ethylene glycol | yes | yes | yes | yes | Yes | yes | Yes | yes | yes |
| mono-butyl ether | | | | | | | | | |

¹yes means 100% uniform distribution, uniform solution
²no means <100% uniform distribution, layer or cloudy in appearance
³Tests not conducted since binary material is not uniformly distributed

TABLE 5C
Oils and Hydrocarbons

| | Polyol | | | | | | | |
|---|---|---|---|---|---|---|---|---|
| | O | | F | | P | | Q | |
| | Type | | | | | | | |
| | | | Aromatic | | | | Linear | |
| | | | carboxylic | | | | Aliphatic | |
| | | | anhydrides | | | | Adipate | |
| | Aromatic | | (phthalic) | | Aromatic | | Diethylene | |
| | polyester | | polyester | | polyester | | Glycol based | |
| | Polyol | | polyol | | polyol Diols | | polyester polyol | |
| hydroxyl # | | | | | | | | |
| 1336 | 360-380 | | 240 | | 295-315 | | 54-58 | |
| UDA | | | | | | | | |
| | | 1336 + | | 1336 + | | 1336 + | | 1336 + |
| 1336 + | polyol + | polyol + | polyol + | polyol + | polyol + | polyol + | polyol + | polyol + |
| UDA | UDA | UDA | UDA | UDA | UDA | UDA | UDA | UDA |

Oils

| | | | | | | | | | |
|---|---|---|---|---|---|---|---|---|---|
| Linseed oil | no² | no | —³ | no | — | no | — | no | — |
| Soybean oil | no | no | — | no | — | no | — | no | — |
| Caster oil | no | no | — | no | — | no | — | no | — |

Hydrocarbons

| | | | | | | | | | |
|---|---|---|---|---|---|---|---|---|---|
| n pentane | yes¹ | no | — | no | — | no | — | no | — |
| Isopentane | yes | no | — | no | — | no | — | no | — |
| cyclopentane | yes | no | — | no | — | no | — | no | — |
| Hexane | yes | no | — | no | — | no | — | no | — |

¹yes means 100% uniform distribution, uniform solution
²no means <100% uniform distribution, layer or cloudy in appearance
³Tests not conducted since binary material is not uniformly distributed

TABLE 5D
Benzenes and Ketones

| | Polyol | | | | | | | |
|---|---|---|---|---|---|---|---|---|
| | O | | F | | P | | Q | |
| | Type | | | | | | | |
| | | | Aromatic | | | | Linear Aliphatic | |
| | | | carboxylic | | | | Adipate | |
| | Aromatic | | anhydrides | | Aromatic | | Diethylene | |
| | polyester | | (phthalic) | | polyester | | Glycol based | |
| | Polyol | | polyester polyol | | polyol Diols | | polyester polyol | |
| hydroxyl # | | | | | | | | |
| 1336 | 360-380 | | 240 | | 295-315 | | 54-58 | |
| UDA | | | | | | | | |
| | | 1336 + | | 1336 + | | 1336 + | | 1336 + |
| 1336 + | polyol + | polyol + | polyol + | polyol + | polyol + | polyol + | polyol + | polyol + |
| UDA | UDA | UDA | UDA | UDA | UDA | UDA | UDA | UDA |

Benzenes

| | | | | | | | | | |
|---|---|---|---|---|---|---|---|---|---|
| 1,3- | yes¹ | no² | —³ | yes | Yes | no | — | no | — |
| Diisopropenyl- | | | | | | | | | |
| benzene | | | | | | | | | |
| Isopropenyl | yes | yes | no | yes | Yes | no | — | yes | yes |
| Benzene | | | | | | | | | |
| Ketones | | | | | | | | | |
| Acetone | yes | yes | no | yes | Yes | yes | No | yes | yes |
| methyl ethyl | yes | yes | no | yes | Yes | yes | No | yes | yes |
| ketone | | | | | | | | | |

¹yes means 100% uniform distribution, uniform solution
²no means <100% uUniform distribution, layer or cloudy in appearance
³Tests not conducted since binary material is not uniformly distributed

TABLE 5E
Blowing Agents

| | | Polyol | | | | | | | |
|---|---|---|---|---|---|---|---|---|---|
| | | O | | F | | P | | Q | |
| | | Type | | | | | | | |
| | | | | Aromatic | | | | Linear Aliphatic | |
| | | | | carboxylic | | | | Adipate | |
| | | Aromatic | | anhydrides | | Aromatic | | Diethylene | |
| | | polyester | | (phthalic) | | polyester | | Glycol based | |
| | | Polyol | | polyester polyol | | polyol Diols | | polyester polyol | |
| | hydroxyl # | | | | | | | | |
| | 1336 | 360-380 | | 240 | | 295-315 | | 54-58 | |
| | UDA | | | | | | | | |
| | | | 1336 + | | 1336 + | | 1336 + | | 1336 + |
| | 1336 + | polyol + | polyol + | polyol + | polyol + | polyol + | polyol + | polyol + | polyol + |
| | UDA | UDA | UDA | UDA | UDA | UDA | UDA | UDA | UDA |
| HFO-1233zd(E) | yes¹ | yes | no² | yes | No | yes | no | yes | yes |
| methyl formate | yes | yes | no | yes | Yes | yes | no | yes | yes |
| formic acid | no | yes | —³ | yes | — | yes | — | yes | — |

¹yes means 100% uniform distribution, uniform solution
²no means <100% uniform distribution, layer or cloudy in appearance
³Tests not conducted since binary material is not uniformly distributed

TABLE 5F
Miscellaneous Solvents and Commonly Used Materials

| | Polyol | | | | | | | |
|---|---|---|---|---|---|---|---|---|
| | O | | F | | P | | Q | |
| | Type | | | | | | | |
| | | | Aromatic | | | | | |
| | | | carboxylic | | | | Linear Aliphatic | |
| | | | anhydrides | | | | Adipate | |
| | Aromatic | | (phthalic) | | Aromatic | | Diethylene | |
| | polyester | | polyester | | polyester | | Glycol based | |
| | Polyol | | polyol | | polyol Diols | | polyester polyol | |
| hydroxyl # | | | | | | | | |
| 1336 | 360-380 | | 240 | | 295-315 | | 54-58 | |
| UDA | | | | | | | | |
| | | 1336 + | | 1336 + | | 1336 + | | 1336 + |
| 1336 + | polyol + | polyol + | polyol + | polyol + | | polyol + | polyol + | polyol + |
| UDA | UDA | UDA | UDA | UDA | polyol + UDA | UDA | UDA | UDA |

Chlorinated solvents

| | | | | | | | | | |
|---|---|---|---|---|---|---|---|---|---|
| trans-1,2- | yes¹ | yes | no² | yes | yes | Yes | no | yes | yes |
| dichloro | | | | | | | | | |
| ethylene | | | | | | | | | |
| 2- | yes | yes | yes | yes | yes | No | —³ | yes | yes |
| chloropropane | | | | | | | | | |
| Carbonates | | | | | | | | | |
| Propylene | yes | yes | no | yes | yes | Yes | no | yes | yes |
| carbonate | | | | | | | | | |

Misc.
compatibilizers, solvents

| | | | | | | | | | |
|---|---|---|---|---|---|---|---|---|---|
| Dioctyl | yes | no | — | yes | yes | No | — | no | — |
| phthalate | | | | | | | | | |
| Toluene | yes | yes | no | yes | yes | Yes | no | yes | yes |
| 1-propoxy-2- | yes | no | — | yes | Yes | No | — | no | — |
| propanol | | | | | | | | | |
| Glycerin | no | no | — | no | — | No | — | no | — |
| tris(1-chloro- | yes | yes | no | yes | No | Yes | no | yes | yes |
| 2-propyl) | | | | | | | | | |
| phosphate | | | | | | | | | |

¹yes means 100% uniform distribution, uniform solution
²no means <100% uniform distribution, layer or cloudy in appearance
³Tests not conducted since binary material is not uniformly distributed

As shown in the Tables 5A-F and Example 1 above, lower molecular weight alcohols are excellent compatibilizers for HFO-1336mzzm(Z) in all polyester polyols tested. For glycols and ethers, the only glycol or ether which is a universal compatibilizer for HFO-1336mzzm(Z) in polyester polyol is ethylene glycol mono-butyl ether. Ethylene glycol, diisopropylene glycol, dipropylene glycol methyl ether, and methylal can be used as compatibilizers for some types of polyester polyols. None of the benzenes, or ketones was a universal compatibilizer for HFO-1336mzzm(Z). However, this class of materials was found to be an effective compatibilizer for HFO-1336mzzm(Z) in the polyester polyols with the lower functionality (e.g., Polyols F and Q). Oils and hydrocarbons provided no compatibilizer capabilities to improve the miscibility of HFO-1336mzzm(Z) in polyester polyols. Co-blowing agents in most instances do not function as compatibilizers at the levels tested. However, HFO-1233zd(E) was a compatibilizer for Polyol Q, and methyl formate was a compatibilizer for polyester polyols with lower functionality (e.g., Polyols F and Q). Many commonly used raw materials do not function as a universal compatibilizer for HFO-1336mzzm(Z) in polyester polyols. However, several are effective for the polyesters polyols with lower functionality. For example, trans-1,2-dichloroethylene, 2-chloropropane, propylene carbonate, and toluene are effective for both Polyols F and Q, while tris(1-chloro-2-propyl) phosphate was effective for Polyol Q, and 1-propoxy-2-propanol was effective for Polyol F.

As can be seen from the above Tables 5A-5F, compatibilizers and mixtures thereof according to the present invention formed uniform distribution of Polyols F and O and HFO-1233zd(E) with the compatibilizer, whereas, as reported in Comparative Example 1, a uniform distribution was not otherwise formed.

### Example 2—Minimum Concentration Ranges

27 grams of the polyol to be evaluated was added to a large vial, and the height of the polyol in the vial was measured. 8 grams of HFO-1336mzzm was added to the vial, and the height of the liquid was measured. The vial was sealed and mixed well. The height of the separated layers was measured (which is the HFO-1336mzzm that was not uniformly distributed in the solution). 0.2 grams of the compatibilizer was added to the vial. The vial was sealed, and the solution was mixed well. The layer height in the vial was recorded. Additional compatibilizer was added to the solution until a uniform solution was achieved. The amount was then recorded. Table 6 shows the results.

### Example 3A: Stability Test: Ternary Mixtures at 4-6 Months

The mixtures of HFO-1336mzzm(Z)+polyol+UDA reported in Tables 5A-5F above were stored in sealed containers under ambient (room temperature) conditions for periods of four to six months to evaluate long term stability. The formation or not of a uniform distribution of the blowing agent and polyol and compatibilizer was reported by visual observation upon initial mixing and upon storage for a period of 4-6 months. Tables 7A-C show the results.

TABLE 6
Effective Levels of Compatibilizers

| | | Polyol | | | | | | | | |
|---|---|---|---|---|---|---|---|---|---|---|
| | | O | | | F | | | P | | |
| | | Type | | | | | | | | |
| | | | | | Aromatic carboxylic | | | | | |
| | | | | | anhydrides (phthalic) | | | Aromatic polyester polyol | | |
| | | Aromatic polyester Polyol | | | polyester polyol | | | Diols | | |
| | hydroxyl # | | | | | | | | | |
| | 1336 | 360-380 | | | 240 | | | 295-315 | | |
| | UDA | | | | | | | | | |
| | | | 1336 + | min | | 1336 + | min | | 1336 + | min |
| | 1336 + | polyol + | polyol + | amount | polyol + | polyol + | amount | polyol + | polyol + | amount |
| | UDA | UDA | UDA | (wt %) | UDA | UDA | (wt %) | UDA | UDA | (wt %) |
| methanol | yes¹ | yes | yes | 8.3 | Yes | yes | 1.7 | yes | yes | >4.3 |
| ethylene glycol | no² | no | —³ | — | yes | no | 0 | yes | yes | >4.3 |
| Ethylene glycol | yes | yes | yes | 10.7 | Yes | yes | 2.2 | yes | yes | 7.6 |
| mono-butyl | | | | | | | | | | |
| ether | | | | | | | | | | |
| Isopropenyl | yes | yes | no | 0 | Yes | yes | 7.1 | no | — | 0 |
| benzene | | | | | | | | | | |
| methyl ethyl | yes | yes | no | 0 | Yes | yes | 7.1 | yes | no | 0 |
| ketone | | | | | | | | | | |
| trans-1,2- | yes¹ | yes | no² | 0 | Yes | yes | 7.1 | yes | no | 0 |
| dichloro | | | | | | | | | | |
| ethylene | | | | | | | | | | |
| Toluene | Yes | Yes | No | 0 | Yes | Yes | 8.4 | Yes | No | 0 |
| Propylene | yes | yes | no | 0 | Yes | yes | 3.3 | yes | no | 0 |
| carbonate | | | | | | | | | | |

¹Yes means 100% uniform distribution, uniform solution
²No means <100% uniform distribution, layer or cloudy in appearance
³Tests not conducted since binary material is not uniformly distributed

TABLE 7A
Stability of Polyol F Mixtures after 4-6 Months Storage

| | Upon Initial Mixing | | | 4-6 Months Storage | |
|---|---|---|---|---|---|
| | 1336 + | polyol + | 1336 + | 1336 + | 1336 + |
| UDA | UDA | UDA | polyol + UDA | UDA | polyol + UDA |

Alcohols

| | | | | | |
|---|---|---|---|---|---|
| Ethanol | yes¹ | yes | yes | yes | yes |
| Methanol | yes | yes | yes | yes | yes |
| Isopropanol | yes | yes | yes | yes | yes |
| n-butanol | yes | yes | yes | yes | yes |
| 2-propanol | yes | yes | yes | yes | yes |
| 1 pentanol | yes | yes | yes | yes | yes |
| 3 methyl 2 butanol | yes | yes | yes | yes | yes |
| 2 methyl 1 propanol | yes | yes | yes | yes | yes |
| Nonylphenol | yes | yes | yes | yes | yes |
| Ethoxylate | | | | | |

Glycols

| | | | | | |
|---|---|---|---|---|---|
| Dipropylene Glycol | Yes | Yes | Yes | Yes | Yes |

Ethers/Acetals

| | | | | | |
|---|---|---|---|---|---|
| dipropylene glycol | Yes | Yes | Yes | Yes | Yes |
| methyl ether | | | | | |
| methylal | Yes | Yes | Yes | Yes | Yes |
| Ethylene glycol mono- | Yes | Yes | Yes | Yes | Yes |
| butyl ether | | | | | |

Benzenes

| | | | | | |
|---|---|---|---|---|---|
| 1,3-Diisopropenyl- | Yes | Yes | Yes | Yes | Yes |
| benzene | | | | | |
| Isopropenyl benzene | Yes | Yes | Yes | Yes | Yes |

Ketones

| | | | | | |
|---|---|---|---|---|---|
| Acetone | Yes | Yes | Yes | Yes | Yes |
| methyl ethyl ketone | Yes | Yes | Yes | Yes | Yes |

Chlorinated solvents

| | | | | | |
|---|---|---|---|---|---|
| trans-1,2-dichloro | Yes | Yes | Yes | Yes | Yes |
| ethylene | | | | | |
| 2-chloropropane | Yes | Yes | Yes | Yes | Yes |

Carbonates

| | | | | | |
|---|---|---|---|---|---|
| Propylene carbonate | Yes | Yes | Yes | Yes | Yes |

Misc. compatibilizers, solvents

| | | | | | |
|---|---|---|---|---|---|
| Dioctyl phthalate | Yes | Yes | Yes | Yes | Yes |
| Toluene | Yes | Yes | Yes | Yes | Yes |
| 1-propoxy-2-propanol | Yes | Yes | Yes | Yes | Yes |

Blowing Agent

| | | | | | |
|---|---|---|---|---|---|
| Methyl formate | Yes | Yes | Yes | Yes | Yes |

¹Yes means 100% uniform distribution, uniform solution

TABLE 7B
Stability of Polyol O Mixtures

| | Upon Initial Mixing | | | 4-6 Months Storage | |
|---|---|---|---|---|---|
| | 1336 + | polyol + | 1336 + | 1336 + | 1336 + |
| UDA | UDA | UDA | polyol + UDA | UDA | polyol + UDA |

Alcohols

| | | | | | |
|---|---|---|---|---|---|
| Ethanol | yes¹ | yes | yes | yes | yes |
| Methanol | yes | yes | yes | yes | yes |
| Isopropanol | yes | yes | yes | yes | yes |
| n-butanol | yes | yes | yes | yes | yes |
| 2-propanol | yes | yes | yes | yes | yes |
| 1 pentanol | yes | yes | yes | yes | yes |
| 3 methyl 2 butanol | yes | yes | yes | yes | yes |
| 2 methyl 1 propanol | yes | yes | yes | yes | yes |
| Nonylphenol | yes | yes | yes | yes | yes |
| Ethoxylate | | | | | |

Ethers/Acetals

| | | | | | |
|---|---|---|---|---|---|
| ethylene glycol mono- | yes | yes | yes | yes | yes |
| butyl ether | | | | | |

Chlorinated solvents

| | | | | | |
|---|---|---|---|---|---|
| 2-chloropropane | Yes | Yes | Yes | Yes | Yes |

¹Yes means 100% uniform distribution, uniform solution

TABLE 7C
Stability of Polyol Q Mixtures

| | Upon Initial Mixing | | | 4-6 Months Storage | |
|---|---|---|---|---|---|
| | 1336 + | polyol + | 1336 + | 1336 + | 1336 + |
| UDA | UDA | UDA | polyol + UDA | UDA | polyol + UDA |

Alcohols

| | | | | | |
|---|---|---|---|---|---|
| Ethanol | Yes¹ | Yes | Yes | Yes | Yes |
| Methanol | Yes | Yes | Yes | Yes | Yes |
| Isopropanol | Yes | Yes | Yes | Yes | Yes |
| n-butanol | Yes | Yes | Yes | Yes | Yes |
| 2-propanol | Yes | Yes | Yes | Yes | Yes |
| 3 methyl 2 butanol | Yes | Yes | Yes | Yes | Yes |
| Nonylphenol | Yes | Yes | Yes | Yes | Yes |
| Ethoxylate | | | | | |

Ethers/Acetals

| | | | | | |
|---|---|---|---|---|---|
| dipropylene glycol | Yes | Yes | Yes | Yes | Yes |
| methyl ether | | | | | |
| methylal | Yes | Yes | Yes | Yes | Yes |
| ethylene glycol mono- | Yes | Yes | Yes | Yes | Yes |
| butyl ether | | | | | |

Benzenes

| | | | | | |
|---|---|---|---|---|---|
| Isopropenyl Benzene | Yes | Yes | Yes | Yes | Yes |

Ketones

| | | | | | |
|---|---|---|---|---|---|
| Acetone | Yes | Yes | Yes | Yes | Yes |
| methyl ethyl ketone | Yes | Yes | Yes | Yes | Yes |

Chlorinated solvents

| | | | | | |
|---|---|---|---|---|---|
| trans-1,2-dichloro | Yes | Yes | Yes | Yes | yes |
| Ethylene | | | | | |
| 2-chloropropane | Yes | Yes | Yes | Yes | yes |

Carbonates

| | | | | | |
|---|---|---|---|---|---|
| Propylene carbonate | yes | Yes | Yes | Yes | yes |

Misc. compatibilizers, solvents

| | | | | | |
|---|---|---|---|---|---|
| Toluene | Yes | Yes | Yes | Yes | yes |
| tris(1-chloro-2-propyl)phosphate | Yes | Yes | Yes | Yes | yes |

Blowing Agents

| | | | | | |
|---|---|---|---|---|---|
| HFO-1233zd(E) | Yes | Yes | Yes | Yes | Yes |
| Methyl formate | Yes | Yes | Yes | Yes | Yes |
| Formic Acid | Yes | Yes | Yes | Yes | Yes |

¹Yes means 100% uniform distribution, uniform solution

### Example 3B: Stability Tests: 1 Year

The ternary mixtures of HFO-1336mzzm(Z)+polyol+UDA reported in Tables 7A-7C above are stored in sealed containers under ambient (room temperature) conditions for a period of one year to evaluate long term stability. The formation or not of a uniform distribution of the blowing agent and polyol and compatibilizer is reported by visual observation upon initial mixing and upon storage for a period of 1 year. The mixtures which showed stability at 4-6 months are observed to be stable at one year.

### Example 3C: Stability Tests: Binary Mixtures at 4-6 Months and 1 Year

The binary mixtures of HFO-1336mzzm(Z)+UDA and polyol+UDA reported in Tables 5A-5F above are stored in sealed containers under ambient (room temperature) conditions for periods of four to six months and 1 year to evaluate long term stability. The formation or not of a uniform distribution of the blowing agent and compatibilizer and polyol and compatibilizer is reported by visual observation upon storage for a period of 4-6 months and 1 year. The binary mixtures are observed to be stable at 4-6 months and 1 year.

### Example 4: Compatibilizers for Use with HFO-1336Mzzm(Z) in 1,4-Butane Diol

A study is undertaken to determine the extent to which certain compatibilizers are able to increase the ability of HFO-1336mzzm(Z) to be uniformly distributed in alkane diols, including particularly butane diols and more particularly 1,4-butane diol.

A first set of tests is performed to demonstrate the ability of various distribution agents to be uniformly distributed in the 1,4-butane diol. Seventeen (17) grams of the 1,4-butane diol to be tested is transferred to a small vial, and the height of the material is recorded. Eight (8) grams of the identified compatibilizer is added to the material, and it is reported whether a uniform distribution is formed upon mixing and then upon storage in a sealed container under ambient (room temperature) conditions for storage periods of 6 months and one year.

A second set of tests is performed to demonstrate the ability of various distribution agents to be uniformly distributed in the blowing agent HFO-1336mzzm (Z). Eight and a half (8.5) grams of the blowing agent was transferred to a small vial, and the height of the blowing agent is recorded. One and half (1.5) grams of the identified compatibilizer is added to the blowing agent, and it is reported whether a uniform distribution is formed upon mixing and then upon storage in a sealed container under ambient (room temperature) conditions for storage periods of 6 months and one year.

A third set of tests is performed to demonstrate the ability of various distribution agents to be uniformly distributed together with the blowing agent HFO-1336mzzm (Z) and the 1,4-butane diol. The mixtures as indicated in the first test and the second test are repeated as indicated above, and then 16 grams of the first mixture (the polyol/compatibilizer mixture) and 4 grams of the second mixture (the HFO-1336mzzm (Z)/compatibilizer mixture) are mixed to form a mixture of the material, the HFO-1336mzzm (Z) and the indicated compatibilizer, which is identified in Table 8 below as “1336+polyol+UDA.” The formation or not of a uniform distribution of the blowing agent and material and compatibilizer is reported by visual observation upon initial mixing and upon storage for a period of 6 months and 1 year in Table 8 below. For the purposes of convenience, the uniform distribution agents are identified in the table as UDA.

TABLE 8

| Upon Initial Mixing | | | 6 Months Storage | | | 1 Year Storage | | |
|---|---|---|---|---|---|---|---|---|
| UDA | | | | | | | | |
| | | 1336 + | | | 1336 + | | | 1336 + |
| 1336 + | polyol + | polyol + | 1336 + | polyol + | polyol + | 1336 + | polyol + | polyol + |
| UDA | UDA | UDA | UDA | UDA | UDA | UDA | UDA | UDA |

Alcohols

| | | | | | | | | | |
|---|---|---|---|---|---|---|---|---|---|
| Ethanol | yes¹ | Yes | yes | Yes | Yes | Yes | yes | Yes | yes |
| Methanol | yes | Yes | yes | Yes | Yes | Yes | yes | Yes | yes |
| Isopropanol | yes | Yes | yes | Yes | Yes | Yes | yes | Yes | yes |
| n-butanol | yes | Yes | yes | Yes | Yes | Yes | yes | Yes | yes |
| 2-propanol | yes | Yes | yes | Yes | Yes | Yes | yes | Yes | yes |
| 1 pentanol | yes | Yes | yes | Yes | Yes | Yes | yes | Yes | yes |
| 3 methyl 2 | yes | Yes | yes | Yes | yes | Yes | yes | Yes | yes |
| butanol | | | | | | | | | |
| 2 methyl 1 | yes | Yes | yes | Yes | yes | Yes | yes | Yes | yes |
| propanol | | | | | | | | | |
| Nonylphenol | yes | Yes | yes | Yes | yes | Yes | yes | Yes | yes |
| Ethoxylate | | | | | | | | | |

Glycols

| | | | | | | | | | |
|---|---|---|---|---|---|---|---|---|---|
| Dipropylene | yes | yes | yes | Yes | yes | Yes | yes | yes | yes |
| Glycol | | | | | | | | | |
| Ethers/Acetals | | | | | | | | | |
| dipropylene | yes | yes | yes | Yes | yes | Yes | yes | yes | yes |
| glycol methyl | | | | | | | | | |
| ether | | | | | | | | | |
| methylal | yes | yes | yes | Yes | yes | Yes | yes | yes | yes |
| ethylene glycol | yes | yes | yes | Yes | yes | Yes | yes | yes | yes |
| butyl mono- | | | | | | | | | |
| ether | | | | | | | | | |

Benzenes

| | | | | | | | | | |
|---|---|---|---|---|---|---|---|---|---|
| 1,3- | yes¹ | yes | yes | Yes | yes | Yes | yes | yes | yes |
| Diisopropenyl- | | | | | | | | | |
| benzene | | | | | | | | | |
| Isopropenyl | yes | yes | yes | Yes | yes | Yes | Yes | yes | yes |
| Benzene | | | | | | | | | |

Ketones

| | | | | | | | | | |
|---|---|---|---|---|---|---|---|---|---|
| Acetone | yes | yes | yes | Yes | yes | Yes | Yes | yes | yes |
| methyl ethyl | yes | yes | yes | Yes | yes | Yes | Yes | yes | yes |
| ketone | | | | | | | | | |

Chlorinated solvents

| | | | | | | | | | |
|---|---|---|---|---|---|---|---|---|---|
| trans-1,2- | yes | yes | yes | Yes | yes | Yes | Yes | yes | yes |
| dichloro | | | | | | | | | |
| Ethylene | | | | | | | | | |
| | yes | yes | yes | Yes | yes | Yes | Yes | yes | yes |
| 2-chloropropane | yes | yes | yes | Yes | yes | Yes | Yes | yes | yes |

Carbonates

| | | | | | | | | | |
|---|---|---|---|---|---|---|---|---|---|
| Propylene | yes | yes | yes | Yes | yes | Yes | Yes | yes | yes |
| carbonate | | | | | | | | | |

Misc. compatibilizers, solvents

| | | | | | | | | | |
|---|---|---|---|---|---|---|---|---|---|
| Dioctyl | yes | Yes | yes | Yes | yes | Yes | Yes | yes | yes |
| phthalate | | | | | | | | | |
| Toluene | yes | Yes | yes | Yes | yes | Yes | Yes | yes | yes |
| 1-propoxy-2- | Yes | Yes | yes | Yes | yes | Yes | Yes | yes | yes |
| propanol | | | | | | | | | |
| tris(1-chloro-2- | Yes | Yes | yes | Yes | yes | Yes | Yes | yes | yes |
| propyl) | | | | | | | | | |
| phosphate | | | | | | | | | |

Blowing Agents

| | | | | | | | | | |
|---|---|---|---|---|---|---|---|---|---|
| HFO-1233zd(E) | Yes | Yes | Yes | Yes | Yes | Yes | Yes | Yes | Yes |
| Methyl formate | Yes | Yes | Yes | Yes | Yes | Yes | Yes | Yes | Yes |

As can be seen from the above Table 8, the compatibilizer and mixtures thereof according to the present invention are all able to form uniform distribution of 1,4-butanediol and HFO-1336mzzm(Z) with the compatibilizer, whereas, as reported in Comparative Example 1, a uniform distribution was not otherwise formed.

### Example 5: Compatibilizers for Use with HFO-1336Mzzm(Z) in Other Polyols

The testing reported in Example 4 above for the polyols is repeated except with each of the polyols identified as Polyol A, Polyol B, Polyol C, Polyol E, Polyol G, Polyol H, Polyol I, Polyol K, Polyol L, Polyol M, Polyol N, aromatic polyethylene terephthalate polyols, and dipropylene glycol polyols. Acceptable results are achieved both upon initial mixing and after the storage periods indicated in Example 2.

Polyols A-E can be used for a variety of foam applications, including, but not limited to, integral skin foams. Polyols F-I can be used for a variety of foam applications, including, but not limited to, board stock foams. Polyols K-O can be used for a variety of foam applications, including, but not limited to spray foams. Polyol P can be used for a variety of foam applications, including, but not limited to board stock foams. Polyol Q can be used for a variety of foam applications, including, but not limited to flexible foams.

### Example 6: Compatibilizers for Use with HFO-1233zd(E) in Polyols

The testing reported in Example 4 above for the polyols is repeated with each of the polyols identified as Polyols A-Q, and polyethylene terephthalate polyols, and dipropylene glycol polyols except with HFO-1233zd(E). Acceptable results are achieved both upon initial mixing and after the storage periods indicated in Example 2.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A polyol premix composition comprising:
a halogenated olefin blowing agent;
a polyester polyol, and
a distribution enhancing component comprising at least one organic compound having from 1 to 40 carbon atoms, said at least one organic compound being present in the premix in amount effective to enhance the ability of said halogenated blowing agent and said polyol to form a stable, substantially uniform blend that remains as a substantially uniform mixture when stored for a period of four (4) months under ambient conditions.

2. The polyol premix composition of claim 1 wherein the distribution-enhancing component has one or more hydroxyl groups and 1 to 25 carbon atoms.

3. The polyol premix composition of claim 2 wherein the distribution-enhancing component comprises alcohols, glycols, ethers, acetals, benzenes, ketones, chlorinated solvents, carbonates, solvents and surfactants.

4. The polyol premix composition of claim 3 wherein the halogenated olefin blowing agent comprises cis-1,1,1,4,4,4-hexafluorobut-2-ene.

5. The polyol premix composition of claim 1 wherein the distribution-enhancing component comprises one or more of non-cyclic alcohols having 1 to 10 carbon atoms, cyclic alcohols having 6 to 40 carbon atoms, alkylphenols and alkylphenol ethoxylates, dipropylene glycol, diisopropylene glycol, dipropylene glycol methyl ether, methylal, ethylene glycol mono-butyl ether, 1,3-diisopropyl benzene, isopropyl benzene, 1,3-diisopropenyl benzene, isopropenyl benzene, acetone, methyl ethyl ketone, 2-chloropropane, trans-1-chloro-3,3,3-trifluoropropene, methyl formate, propylene carbonate, dioctyl phthalate, toluene; and
the halogenated olefin blowing agent comprises cis-1,1,1,4,4,4-hexafluorobut-2-ene.

6. The polyol premix composition of claim 5 wherein the distribution-enhancing component comprises one or more of ethanol, methanol, isopropanol, n-butanol, 2-propanol, 1 pentanol, 3-methyl-2-butanol, and 2-methyl-1-propanol.

7. The polyol premix composition of claim 1 wherein the distribution-enhancing component is present in an amount of 0.5 wt % to 10 wt % based on a total amount of the blend.

8. A polyol premix composition comprising:
a polyester polyol;
a halogenated olefin blowing agent; and
a distribution-enhancing component comprising at least one organic compound having from 1 to 40 carbon atoms, wherein the distribution-enhancing component is present in the polyol premix composition in an amount effective to enhance the ability of the halogenated olefin blowing agent and the polyester polyol to form a stable, substantially uniform composition.

9. The polyol premix composition of claim 8 wherein:
the distribution-enhancing component has one or more hydroxyl groups and 1 to 25 carbon atoms.

10. The polyol premix composition of claim 8 wherein the distribution-enhancing component comprises one of more of alcohols, glycols, ethers, acetals, benzenes, ketones, chlorinated solvents, carbonates, solvents and surfactants.

11. The polyol premix composition of claim 8 wherein the halogenated olefin blowing agent comprises cis-1,1,1,4,4,4-hexafluorobut-2-ene.

12. The polyol premix composition of claim 11 wherein the distribution-enhancing component is present in an amount of at least 1.7 wt % of the polyol premix composition and comprises one or more of ethanol, methanol, isopropanol, n-butanol, 2-propanol, 1 pentanol, 3-methyl-2-butanol, and 2-methyl-1-propanol.

13. The polyol premix composition of claim 8 wherein the polyester polyol and an optional additional polyol are present in an amount of 50 wt % to 98 wt % of the polyol premix composition, wherein the halogenated olefin blowing agent is present in an amount of 0.25 wt % to 50 wt % of the polyol premix composition, and wherein the distribution-enhancing component is present in an amount of 0.01 wt % to 10 wt % of the polyol premix composition.

14. The polyol premix composition of claim 8 wherein the polyester polyol and optional additional polyol are present in an amount of 80 wt % to 95 wt % of the polyol premix composition, wherein the halogenated olefin blowing agent is present in an amount of 0.25 wt % to 10 wt % of the polyol premix composition, and wherein the distribution-enhancing component is present in an amount of 0.01 wt % to 10 wt % of the polyol premix composition.

15. The polyol premix composition of claim 8 wherein the stable, substantially uniform composition remains as a substantially uniform mixture when stored for a period of four months under ambient conditions.

16. A method of forming a polyol premix composition comprising:
combining a polyester polyol; a halogenated olefin blowing agent; and a distribution-enhancing component comprising at least one organic compound having from 1 to 40 carbon atoms, wherein the distribution-enhancing component is present in the polyol premix composition in an amount sufficient to enhance the ability of the halogenated olefin blowing agent and the polyester polyol to form a stable, substantially uniform composition.

17. The method of claim 16 wherein the distribution-enhancing component comprises alcohols, glycols, ethers, acetals, benzenes, ketones, chlorinated solvents, carbonates, solvents and surfactants and wherein the halogenated olefin blowing agent comprises cis-1,1,1,4,4,4-hexafluorobut-2-ene.

18. The method of claim 16 wherein the stable, substantially uniform composition remains as a substantially uniform mixture when stored for a period of four months under ambient conditions.

19. A foamable composition comprising a mixture of an organic polyisocyanate and the polyol premix composition of claim 8.

20. The foamable composition of claim 19 wherein the organic polyisocyanate comprises a polymethylene polyphenyl isocyanate, methylenebis(phenyl isocyanate), toluene diisocyanate, or combinations thereof.
